(19) United States
(12) Patent Application Publication
(10) Pub. No.: US 2009/0259952 A1
(43) Pub. Date: Oct. 15, 2009

(54) INFORMATION PROCESSING APPARATUS AND METHOD OF CONTROLLING SAME

(75) Inventors: Kenichiro Nakagawa, Tokyo (JP); Makoto Hirota, Tokyo (JP); Hiroki Urashima, Kawasaki-shi (JP); Masaji Munekuni, Kawasaki-shi (JP); Tsunekazu Arai, Tama-shi (JP); Shigeki Hirooka, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/421,384

(22) Filed: Apr. 9, 2009

(30) Foreign Application Priority Data
Apr. 14, 2008 (JP) 2008-104946
Apr. 1, 2009 (JP) 2009-089582

(51) Int. Cl. G06F 3/00

(52) U.S. Cl. 715/762

(57) ABSTRACT

UI widget content includes reference information by which its own UI widget refers to a child UI widget, and a description of an initial-focus designation for designating which of its own UI widget and child UI widget will have initial focus. A self-UI widget is generated, a child UI widget associated with the self-UI widget is generated based upon the reference information, and a UI widget hierarchy is thus built. A path is followed from a root of the UI widget hierarchy to a child UI widget designated by the corresponding initial-focus designation information. When a UI widget for which a child UI widget has not been designated in the corresponding reference information is retrieved, it is determined that this UI widget is the UI widget having the initial focus.

### BACKGROUND OF THE INVENTION

1. Field of the Invention

The present invention relates to a technique for presenting a user interface to a user.

2. Description of the Related Art

Conventionally, most user interfaces (also referred to as “UI” below) of devices or services are created by the C or Java programming language and are installed in the device or service. In recent years, however, user interfaces have come to be created as UI content and can be displayed by a general-purpose browser, thereby making it possible to present the UI to the user.

For example, a pizza delivery service is using HTML to describe a UI for accepting a pizza order from a customer and makes the UI available to the public by means of the Internet. When the customer displays this HTML using an Internet browser, a UI employing animations and audio is displayed. This makes it possible for the customer to readily place an order for a pizza size, number of pies, topping and drink, etc., via the UI.

The following are two advantages of presenting the UI of a device or service by creating UI content rather than by programming:

(1) It is possible to update the UI merely by rewriting the UI content (an HTML file in the example above). If a UI has been created by programming, it is necessary to replace the program in the device. In many cases this is a greater task than rewriting the UI content.

(2) By utilizing an existing browser, it is unnecessary to install the rendering of images that form the UI and the output of audio. Learning description specifications such as HTML is easier than learning a program for creating an UI.

In view of these advantages, description of a UI by UI content is coming into widespread use, with the focus being Internet services.

Recently, the UIs not only of Internet services but also of devices (personal computers, TVs, mobile telephones, etc.) have come to be created by UI content. For example, in Multimodal Interaction Activity (http://www.w3.org/2002/mmi/), a standard specification for UI description is being studied. Further, XAML (Extensible Application Markup Language) proposed by Microsoft has been installed in Windows Vista.

A UI incorporates a concept referred to as “focus”. Focus expresses in what form a non-directional user operation will be input. For example, a keyboard input generally is a non-directional input. In the case of a UI having several text-input areas, in which text-input area text will be entered cannot be ascertained by the user if the focus is not designated. Generally, focus is expressed by enclosing the UI widget (a component such as a text area, button or check box forming the UI) within a rectangle formed by a dotted line. This information makes it possible for the user to ascertain in which text input area the present keyboard input will be entered.

A widget that is the focus initially when the UI is displayed is referred to as the “initial-focus UI widget”. Which UI widget will receive the initial focus is decided by the designer of the UI content. Usability is enhanced if the UI widget having a high likelihood of being accessed by the user first is made the initial-focus UI widget. Where the initial focus is set often is described within the UI content.

Further, UI widgets can be made hierarchical. FIG. 5 is an example of certain UI widgets. The hierarchy of these UI widgets is as illustrated in FIG. 6. Here reference numerals 501, 502, 503, 504, 505, 506, 507, 508 and 509 correspond to 601, 602, 603, 604, 605, 606, 607, 608 and 609, respectively. By expressing a UI by a set of UI widgets having a hierarchical relationship, another UI developer or oneself can re-utilize UI widgets created in the past.

With UI widgets in which existing UI widgets can thus be re-utilized and placed in hierarchical form, it is difficult to set the initial-focus UI widget in line with the intent of the UI developer. For example, with regard to UI widget 501 in FIG. 5, assume that a radio button 507 has been made the initial-focus UI widget. FIG. 7 illustrates UI widgets in which another UI developer has combined two UI widgets 501 (namely 702 and 703). Here the UI widgets 702 and 703 have been described in such a manner that UI widgets 704 and 705 will be the initial-focus UI widgets. In a case where this UI content is displayed, which of the UI widgets 704, 705 is set as the initial-focus UI widget is left to operation of the browser displayed. Consequently, the UI developer who combined the UI widgets 702, 703 cannot control which designation of initial focus should be adopted for these UI widgets.

Japanese Patent Laid-Open No. 2002-215278 discloses a technique whereby the focus of a UI widget is changed automatically based upon a history of operations performed by the user. Further, Japanese Patent No. 3186726 discloses a technique relating to a tool for verifying whether identical UI widgets within an application possess the same initial focus.

However, these examples of the prior art cannot solve the problem set forth above.

### SUMMARY OF THE INVENTION

The present invention seeks to provide an information processing apparatus and method of controlling same in which it is possible to designate an initial focus that reflects the intentions of both the UI developer of a UI widget for which initial focus has been designated and the UI developer of a UI widget that incorporates this UI widget.

According to one aspect of the present invention, an information processing apparatus for presenting a user interface (UI) includes a reading unit configured to read widget content in which arrangement of UI widgets is described, a building unit configured to parse the widget content that has been read and build a plurality of UI widgets, a determining unit configured to determine a UI widget having initial focus placed in a selected state first from among the plurality of UI widgets built, and a presenting unit configured to create images of the plurality of UI widgets and to process the UI widget having the initial focus, which has been determined by the determining unit, into an image representing that this UI widget is in the selected state, and present this image to the user. The widget content includes reference information by which its own UI widget refers to a child UI widget, and a description of an initial-focus designation for designating which of its own UI widget and child UI widget will have the initial focus. The building unit generates its own UI widget and thereafter generates a child UI widget, which is associated with its own UI widget, based upon the reference information, thereby building a UI widget hierarchy. The determining unit follows a path from a root of the UI widget hierarchy to a child UI widget designated by the corresponding initial-focus designation and, when a UI widget for which a child UI widget has not been designated in the corresponding reference information, a UI widget for which its own UI widget has been designated in the corresponding initial-focus designation or a UI widget for which there is no corresponding initial-focus designation has been retrieved, determines that this UI widget is the UI widget having the initial focus.

Further features of the present invention will become apparent from the following description of exemplary embodiments (with reference to the attached drawings).

### BRIEF DESCRIPTION OF THE DRAWINGS

FIG. 1 is a diagram illustrating the functional configuration of a UI presenting apparatus to which the present invention is applicable;

FIG. 2 is a flowchart illustrating processing executed by a UI presenting apparatus in an embodiment;

FIG. 3 is a flowchart illustrating processing for building a UI widget in an embodiment;

FIG. 4 is a flowchart illustrating processing for deciding initial focus in an embodiment;

FIG. 5 is a diagram showing an example of a graphical user interface indicating UI widgets;

FIG. 6 is a diagram illustrating an example of a hierarchical structure of UI widgets;

FIG. 7 is a diagram showing an example of a graphical user interface in which existing UI widgets are re-utilized;

FIG. 8 is a diagram illustrating an example of UI widget content in an embodiment;

FIG. 9 is a diagram illustrating an example of a UI widget hierarchy having a designation of initial focus;

FIG. 10 is a diagram illustrating an example of UI widget content in an embodiment;

FIG. 11 is a diagram illustrating an example of a task hierarchy in an embodiment;

FIG. 12 is a diagram illustrating an example of task content in an embodiment;

FIG. 13 is a diagram illustrating an example of the hardware configuration of an information processing apparatus for implementing the functions of a UI presenting apparatus in an embodiment;

FIG. 14 is a diagram illustrating the functional configuration of a UI widget content creating apparatus;

FIG. 15 is a diagram illustrating an example of an operation screen in an application for creating UI widget content;

FIG. 16 is a diagram illustrating an example of an operation screen in an application for creating UI widget content;

FIG. 17 is a diagram illustrating an example of an operation screen in an application for creating UI widget content;

FIGS. 18A to 18C are diagrams illustrating examples of UI widget content when a UI widget hierarchy is constructed;

FIGS. 19A and 19B are diagrams illustrating examples of operation screens in an application for creating UI widget content;

FIGS. 20A and 20B are diagrams illustrating examples of UI widget content when initial focus has been designated;

FIG. 21 is a flowchart illustrating an example of operation of an apparatus for creating UI widget content;

FIG. 22 is a flowchart illustrating an example of an operation for inserting a child UI widget in an apparatus for creating UI widget content;

FIG. 23 is a flowchart illustrating an example of an operation for setting initial focus in an apparatus for creating UI widget content;

FIG. 24 is a diagram illustrating an example of an operation screen in an application for creating UI widget content;

FIG. 25 is a diagram illustrating an example of an operation screen in an application for creating UI widget content;

FIG. 26 is a diagram illustrating an example of an operation screen in an application for creating UI widget content;

FIGS. 27A and 27B are diagrams illustrating examples of UI widget content when a UI widget hierarchy is constructed;

FIGS. 28A and 28B are diagrams illustrating examples of operation screens in an application for creating UI widget content;

FIGS. 29A and 29B are diagrams illustrating examples of UI widget content when a designation of initial focus has been performed;

FIG. 30 is a diagram illustrating an example of a device UI in a second embodiment;

FIG. 31 is a diagram illustrating an example of UI widget hierarchy in a second embodiment;

FIG. 32 is a diagram illustrating an example of UI widget hierarchy in a fourth embodiment;

FIG. 33 is a diagram illustrating an example of a device UI in a fourth embodiment;

FIG. 34 is a flowchart illustrating an example of a routine for deciding initial focus in a fourth embodiment;

FIG. 35 is a diagram illustrating an example of UI widget hierarchy in a fifth embodiment;

FIG. 36 is a diagram illustrating an example of UI widget content in a fifth embodiment;

FIG. 37 is a flowchart illustrating an example of a routine for deciding initial focus in a fifth embodiment;

FIG. 38 is a diagram illustrating an example of the hierarchical structure of a UI widget; and

FIG. 39 is a system diagram of a UI presenting apparatus and UI widget content creating apparatus to which the present invention is applicable.

### DESCRIPTION OF THE EMBODIMENTS

Various exemplary embodiments, features and aspects of the present invention will be described in detail with reference to the drawings.

### First Embodiment

Terms will be defined first. In this specification, an element that combines appearance and function as a continuum forming a UI is referred to as a “UI widget”. Examples are GUI buttons, text areas and background bitmap images often used in a GUI.

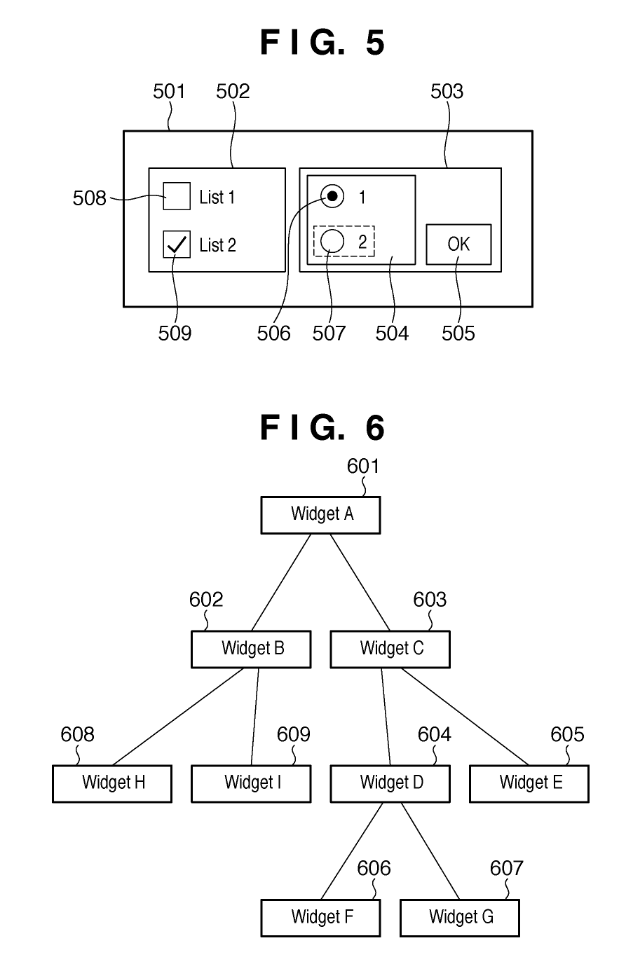

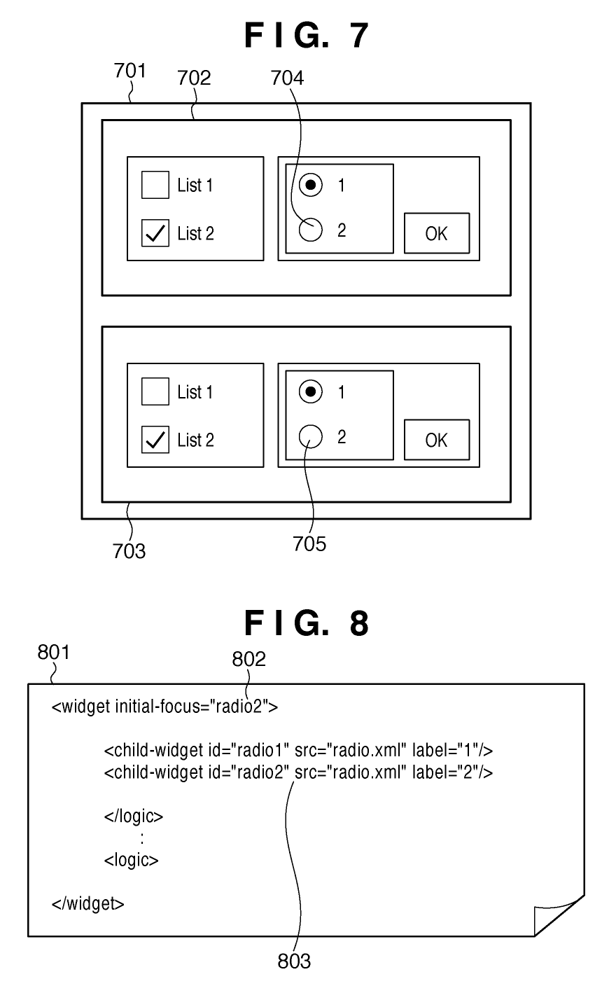

Internal data that expresses a UI widget is referred to as “UI widget content”. FIG. 8 illustrates an example of UI widget content representing a radio-button group 504 in FIG. 5. As illustrated in this example, the UI widget content is capable of being expressed in the XML format. A byte code obtained by binarizing this XML format can also be adopted as UI widget content.

It is possible for UI widget content of the kind shown in FIG. 8 to describe the appearance of this widget, an animation thereof and information about behavior thereof, namely what action will be taken if a certain event occurs. Further, the UI widget content can also possess information 803 that refers to a child UI widget. The example of the UI widget content of FIG. 8 expresses that the UI widget content possesses two child widgets, namely radio1 and radio2. It is possible for UI widgets to be expressed in the form of a tree structure owing to the property that UI widget content can possess child UI widgets.

For example, in the case of the UI screen of FIG. 5, the UI screen can be expressed by the UI widgets 501 to 509. The UI widgets 501 to 509 are expressed by UI widget content 101 in a storage device, and a UI widget hierarchy constructing unit 105 builds the UI widget hierarchy of the kind shown in FIG. 6. The reference numerals 501 to 509 correspond to widgets 601 to 609, respectively. The parent-child relationship in this hierarchy represents parent-child relationship of the UI widgets. For example, reference numeral 504 in FIG. 5 denotes a radio-button group. The radio-button group includes two radio buttons (506, 507). Thus, a “Widget F” (606) and a “Widget G” (607) are formed as children of “Widget D” (604). This arrangement is advantageous in that re-utilization of UI widgets is enhanced by expressing the UI in the form of a hierarchical structure. For example, in a case where this radio-button group is subsequently re-utilized by another UI, the partial tree in which “Widget D” (604) is the parent need only be incorporated in the UI.

A UI presenting apparatus to which the present invention is applicable parses UI widget content that has been placed in hierarchical form and presents the UI to the user. However, in order that a UI presenting apparatus to which the present invention is applicable can operate, UI widget content that has been created by a UI widget content creating apparatus must be in completed form.

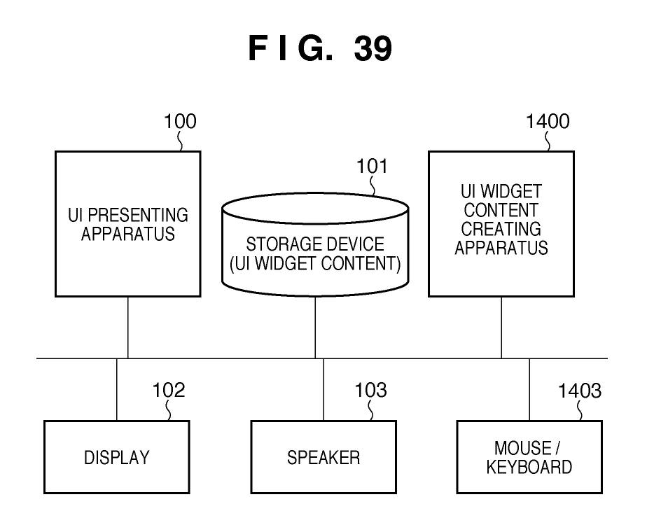

FIG. 39 is a system diagram of a UI presenting apparatus 100 and UI widget content creating apparatus 1400. The UI widget content creating apparatus 1400 creates and edits UI widget content 101 in a storage device in response to operation by a user via a mouse/keyboard 1403. The UI presenting apparatus 100 refers to UI widget content 101 in the storage device and presents the UI to the user via a display 102 or speaker 103.

Next, the UI widget content creating apparatus 1400 and UI presenting apparatus 100 will be described.

[UI Widget Content Creating Apparatus]

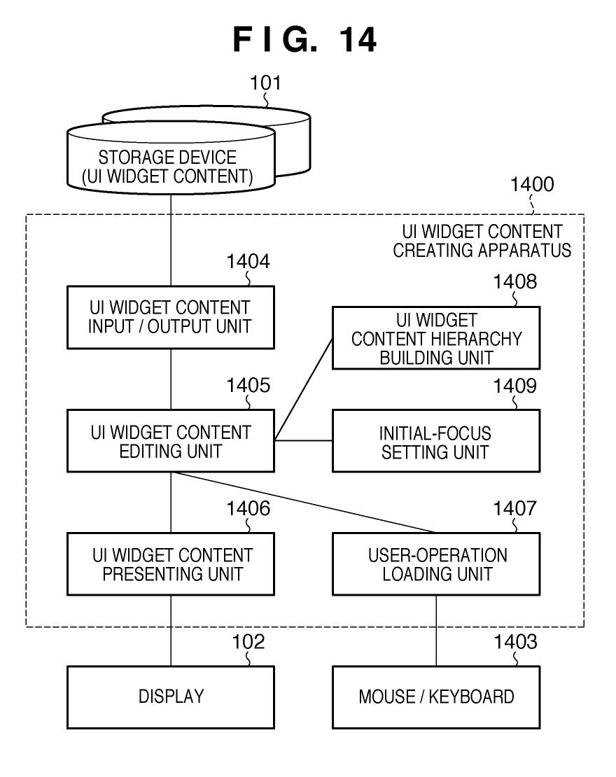

Processing for editing UI widget content and building a UI widget hierarchy will now be described. FIG. 14 is a diagram illustrating the functional configuration of a UI widget content creating apparatus.

The UI widget content creating apparatus 1400 accesses the storage unit 101, which is external to the apparatus, from a UI widget content input/output unit 1404, loads UI widget content and saves this content. Further, an operation performed by the user via the mouse/keyboard 1403 external to the apparatus is accepted within the apparatus from a user-operation loading unit 1407. Information concerning UI widget content that is being edited in the apparatus is output from a UI widget content presenting unit 1406 to a display 102 external to the apparatus.

Further, a UI widget content editing unit 1405 parses user operation and, if this operation is building of a UI widget hierarchy (insertion of a child UI widget), so notifies a UI widget content hierarchy building unit 1408. If the operation performed by the user is the setting of initial focus, then an initial-focus setting unit 1409 is so notified. The flow of this processing will be described later.

<Creation of UI Widgets Anew>

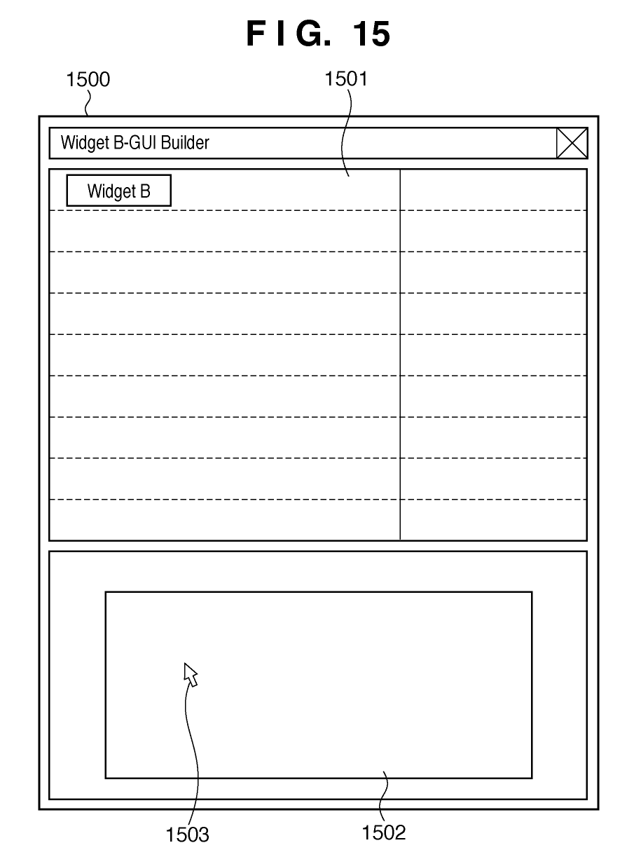

FIG. 15 illustrates an example of a GUI screen (1500) of a UI widget content creating application that incorporates the UI widget content creating apparatus 1400. This example illustrates a screen that prevails when a UI developer A newly creates UI widget content named “Widget B”. A UI widget content creating application 1500 has a UI-widget hierarchical structure presentation area (1501) and UI-widget appearance presentation area (1502). The UI developer A edits UI widget content by performing an editing operation using these areas.

Illustrated as an example is a procedure by which the UI developer A newly creates check boxes represented by 502, 508 and 509 in FIG. 5. It should be noted that the items 502, 508 and 509 are referred to by their names “Widget B”, “Widget H” and “Widget I”, respectively.

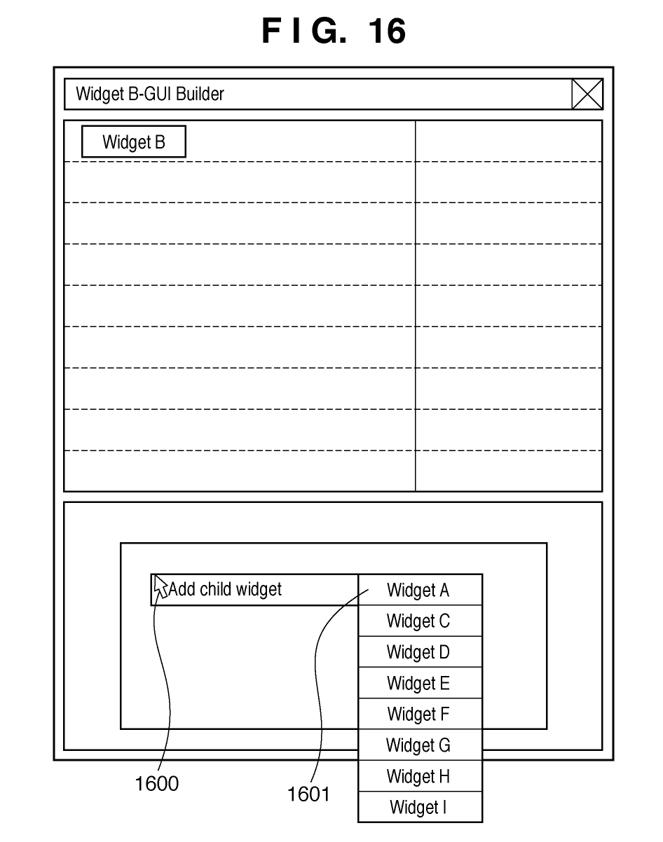

First, when “Widget B” is edited as shown in FIG. 16, the UI developer A right-clicks a mouse (1600) in the UI-widget appearance presentation area. When this is done, the UI widget content editing unit 1405 is notified of this operation via the user-operation loading unit 1407. Accordingly, a context menu (1601) is displayed and an item reading “Add child widget” appears in the menu. If this item is selected, a list of UI widgets is presented in the UI widget content hierarchy building unit 1408. This can be implemented by displaying a list of the UI widget content, which has been stored in the storage device 101, via the UI widget content input/output unit 1404. From among the UI widgets presented, the UI developer A selects the UI widget desired to be set as a child widget. For example, it is assumed here that “Widget H” has been selected. When this is done, “Widget H” is added on as the child of “Widget B” and appearance (1701) of the UI possessed by “Widget H” of the kind shown in FIG. 17 is generated in the UI widget content presenting unit 1406. The appearance thus generated is presented in a UI-widget hierarchical structure presentation area (1700). It is also possible to add on “Widget I” as a child UI widget by performing a similar operation.

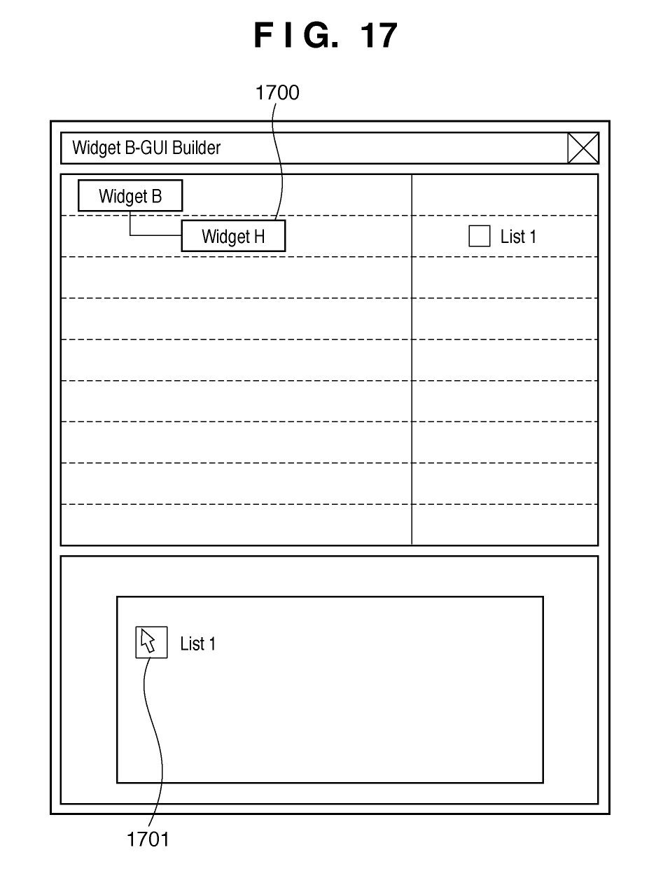

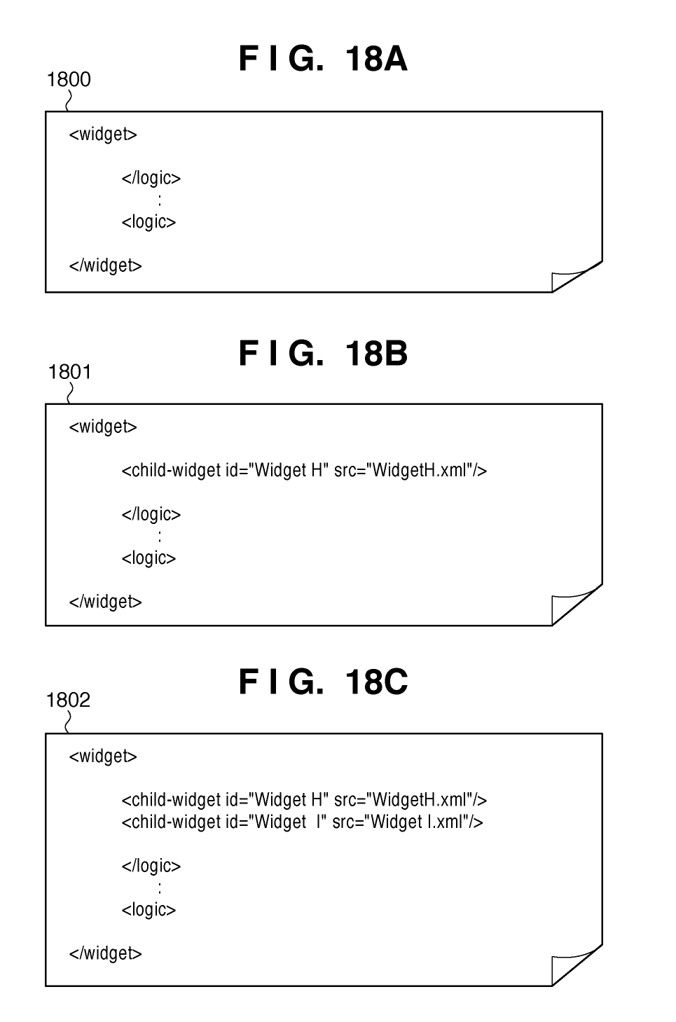

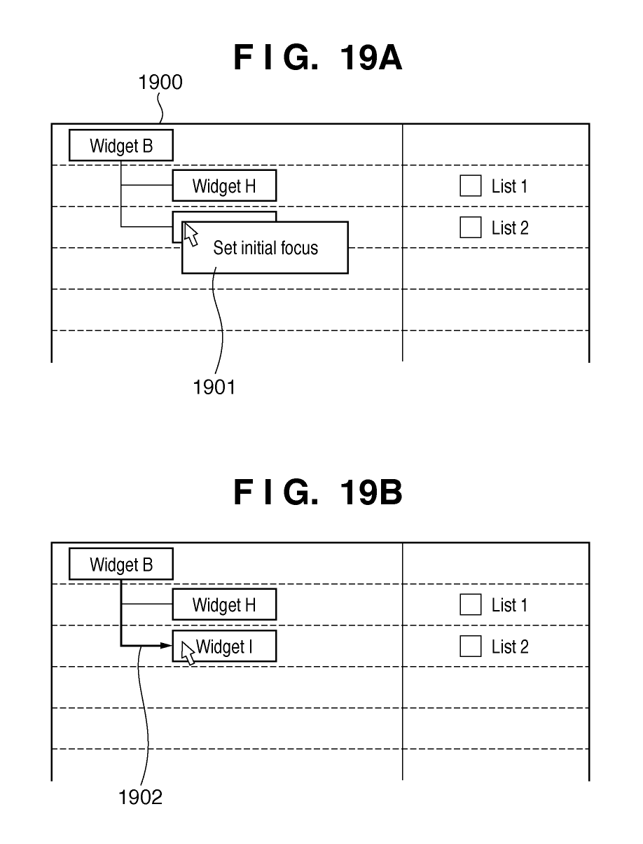

FIGS. 18A to 18C illustrate the state of the internal data of the UI widget content of “Widget B” at this time. FIG. 18A illustrates the state (1800) initially when the widget has no child widgets. This content indicates that there is no element called <child-widget> and that no child has been set. FIG. 18B illustrates the state (1801) which prevails when the operation up to FIG. 17 has been performed and “Widget H” comes to be possessed as a child. Here a <child-widget> element exists for “Widget H”. FIG. 18C illustrates the state (1802) which prevails when “Widget I” also comes to be possessed as a child.

Furthermore, the application for creating UI widget content makes it possible to set a child UI widget as the initial focus. FIGS. 19A and 19B illustrate a situation when such an operation is performed. As shown in FIG. 19A, when the mouse cursor is placed on a UI widget displayed in UI-widget hierarchical structure presentation area (1900) and the mouse is right-clicked, this operation is sent to the UI widget content editing unit 1405 via the user-operation loading unit 1407. A context menu (1901) is displayed in response to this operation. An item “Set initial focus” appears in the context menu. If the UI developer A selects this item, the instruction is sent to the initial-focus setting unit 1409 and a setting that makes the child UI widget the initial focus is made. Then, as illustrated in FIG. 19B, a display (1902) expressing this setting is generated by the UI widget content presenting unit 1406 and is presented to the UI developer A via the display 102. In this example, the appearance changes to one in which there is an arrow extending from “Widget B” to “Widget I”, and this expresses the fact that the initial focus has been set to “Widget I” under “Widget B”.

Finally, when the UI developer A designates that this data should be saved, this instruction is sent to the UI widget content editing unit 1405 via the user-operation loading unit 1407. Here the internal data of the UI widget content is sent to the UI widget content input/output unit 1404 and is stored in the storage device 101.

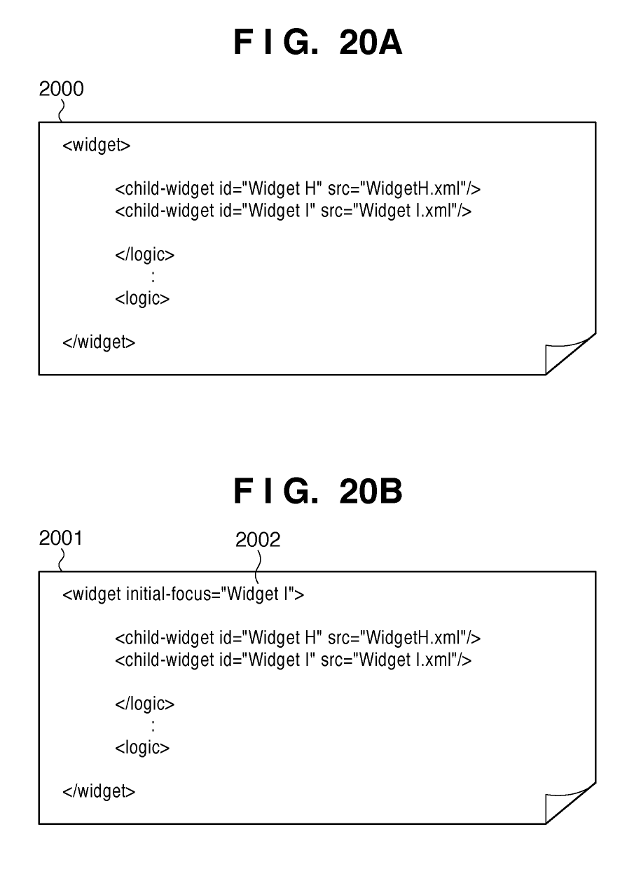

FIGS. 20A and 20B are diagrams for describing how internal data of the UI widget content of “Widget B” has been changed by the operation performed thus far. FIG. 20A illustrates the state (2000) initially when initial focus has not been set to any child. This indicates that <widget> of the root element does not have an “initial-focus” attribute and that initial focus has not been set to any child. FIG. 20B illustrates the state (2001) which prevails when the operation up to FIGS. 19A, 19B has been performed and the initial focus has been set to “Widget I”. The attribute “initial-focus” is attached to <widget>, and this indicates “Widget I” of the child UI widgets.

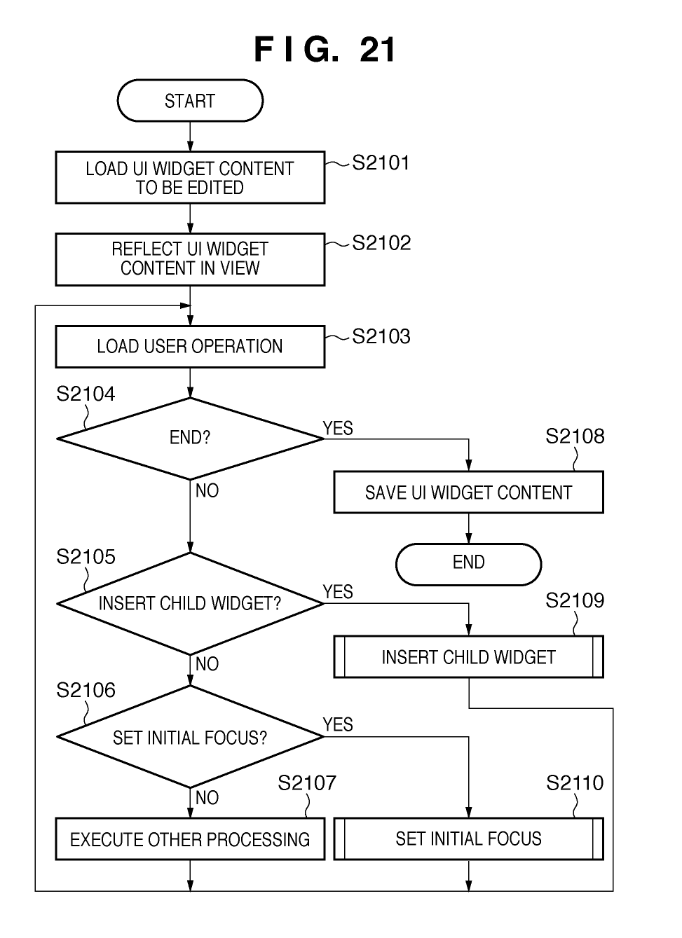

FIG. 21 is a flowchart illustrating processing executed by the UI widget content editing unit 1405, which is the core of the UI widget content creating apparatus 1400. Processing will be described with reference to FIG. 21.

When the UI widget content creating apparatus is started up, the flow of processing begins. When processing starts, first the UI widget content input/output unit 1404 accesses the storage device 101 and loads the UI widget content that is to be edited (S2101). For example, an ordinary file-input dialog screen is displayed and the user is queried about the UI widget content desired to be edited. Here it is conceivable that the UI widget content will be loaded. Alternatively, in a case where a UI widget is created anew, the user may be allowed to enter the name of the UI widget to be created anew, the form of the UI widget content may be created in the storage device and this may then be loaded.

When loading of the UI widget content to be edited ends, the UI widget content presenting unit 1406 reflects this UI widget content in “View” (S2102). For example, a view of the kind shown in FIG. 15 is presented to the user. It should be noted that in a case where the loaded UI widget content has been edited in the past, the result of past editing is presented to the user, as shown in FIG. 17.

Next, the user-operation loading unit 1407 loads the operation performed by the user (S2103) and processing branches in the UI widget content editing unit 1405 depending upon the operation.

First, if user operation designates end of operation of the apparatus (“YES” at S2104), then the UI widget content being edited is saved in the UI widget content input/output unit 1404 (S2108) and the flow of processing is exited. The designation to end operation of the apparatus is processing for quitting the application, by way of example.

If the user operation designates insertion of a UI widget (“YES” at S2105), then the UI widget content hierarchy building unit 1408 executes processing for inserting the UI widget (S2109). This is processing for setting UI widget content, which has been selected by the user, as a child of the UI widget content that is being edited. For example, the instruction to insert a child UI widget can be an operation in which the user right-clicks the mouse in the UI-widget appearance presentation area and selects the “Add child widget” item from the context menu, as illustrated in FIG. 16.

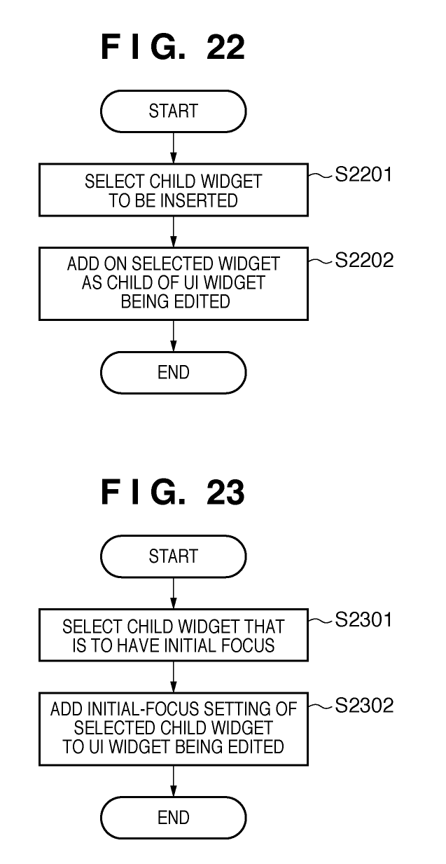

FIG. 22 is a flowchart of UI-widget insertion processing executed in the UI widget content hierarchy building unit 1408. The first step of this processing is acquisition of the UI widget to be inserted (S2201). For example, it may be so arranged that when the “Add child widget” item is selected from the context menu, a list of UI widgets is presented and the user is allowed to make the selection, as illustrated in FIG. 16. Next, the selected widget is added on as the child of the UI widget being edited (S2202). More specifically, the element <child-widget> can be added to the UI widget content being edited and information concerning the selected UI widget can be applied as the attribute thereof, as shown in FIGS. 18B and 18C.

With reference again to FIG. 21, if the user operation performed is an instruction to set the initial focus (“YES” at S2106), then the initial-focus setting unit 1409 executes processing for setting the initial focus (S2110). This is processing for setting a specific child UI widget as the initial focus. For example, this instruction for setting the initial focus can be an operation in which the user right-clicks the mouse on the child UI widget in the UI-widget hierarchical structure presentation area and selects the “Set initial focus” item from the context menu, as illustrated in FIGS. 19A and 19B.

FIG. 23 is a flowchart of processing for setting initial focus executed by the initial-focus setting unit 1409. The first step of this processing is selection of a child UI widget that is to receive the initial focus (S2301). In the example of FIGS. 19A and 19B, the mouse is right-clicked on the child UI widget. Accordingly, the child UI widget thus right-clicked may be regarded as the child UI widget that is to receive the initial focus. Next, the initial-focus setting of the selected child UI widget is added to the UI widget being edited (S2302). More specifically, the “initial-focus” attribute may be added onto the UI widget content currently being edited and the name of the selected child UI widget may be described as the value of the attribute, as illustrated in FIGS. 20A and 20B.

With reference again to FIG. 21, if the operation performed by the user is not an instruction to end operation of the apparatus, not an instruction to insert a child UI widget and not an instruction to set initial focus, then a prescribed operation other than these is carried out (S2107). For example, in a case where the operation is to move the position of the appearance of the child UI widget, the position of the appearance of the child UI widget is used to the position sought by the user. Alternatively, in a case of an instruction to undo operations performed by the user thus far, an undo operation is carried out. These processing operations are executed by the UI widget content editing unit 1405.

When these processing operations end, the UI widget content presenting unit 1406 causes the UI widget content currently being edited to be reflected in “View” (S2102). For example, in a case where the user operation was insertion of a child UI widget, the UI widget content presenting unit 1406 adds the appearance of the child UI widget to the UI-widget appearance presentation area and adds the information concerning the child UI widget to the UI-widget hierarchical structure presentation area.

These processing operations continue until the user specifies end of processing.

<Re-Editing of Already Created UI Widget>

Thus far, the creation of a UI widget anew has been described. Described next will be an operation in which a UI developer C re-utilizes UI widgets that have been created by UI developers A and B and creates a new UI widget.

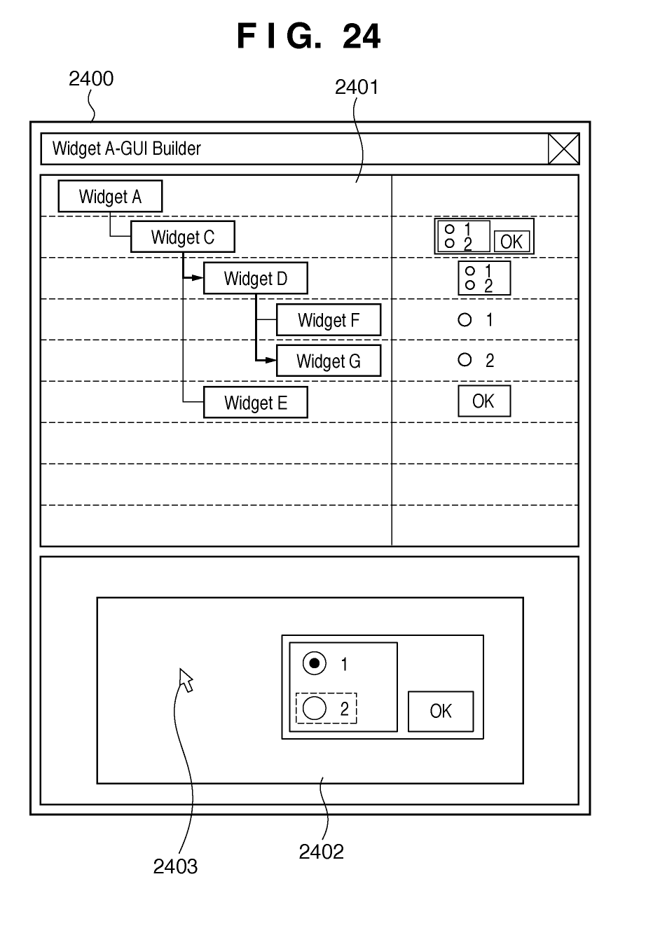

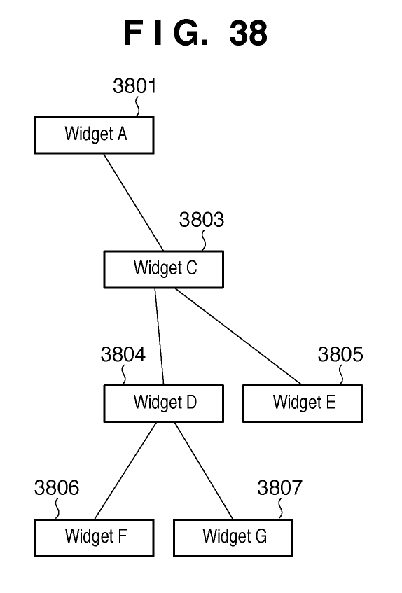

FIG. 24 illustrates a situation in which UI widget content already created has been loaded. For example, it is assumed here that UI widget content referred to as “Widget A” having the hierarchy shown in FIG. 38 has been loaded. It should be noted that “Widget A” possesses only a child widget referred to as “Widget C” created by UI developer B. Processing whereby a “Widget B” created by the UI developer A is added on as a child will now be described.

If UI developer C specifies the loading of existing UI widget content by operating the mouse/keyboard 1403, this operation is sent to the UI widget content editing unit 1405 via the user-operation loading unit 1407. When this is done, the UI widget content editing unit 1405 loads the designated UI widget content from the storage device 101 via the UI widget content input/output unit 1404.

When loading is completed, an application 2400 for creating UI widget content presents information concerning the loaded UI widget content to the display 102 of developer C from the UI widget content presenting unit 1406. For example, the application presents the UI widget hierarchy in a UI-widget hierarchical structure presentation area (2401) and presents the appearance of the UI widget in a UI-widget appearance presentation area (2402). Now assume that the UI widget content having the hierarchy expressed in FIG. 38 has been loaded. The user is capable of editing the appearance, etc., of the UI widget using a mouse pointer (2403).

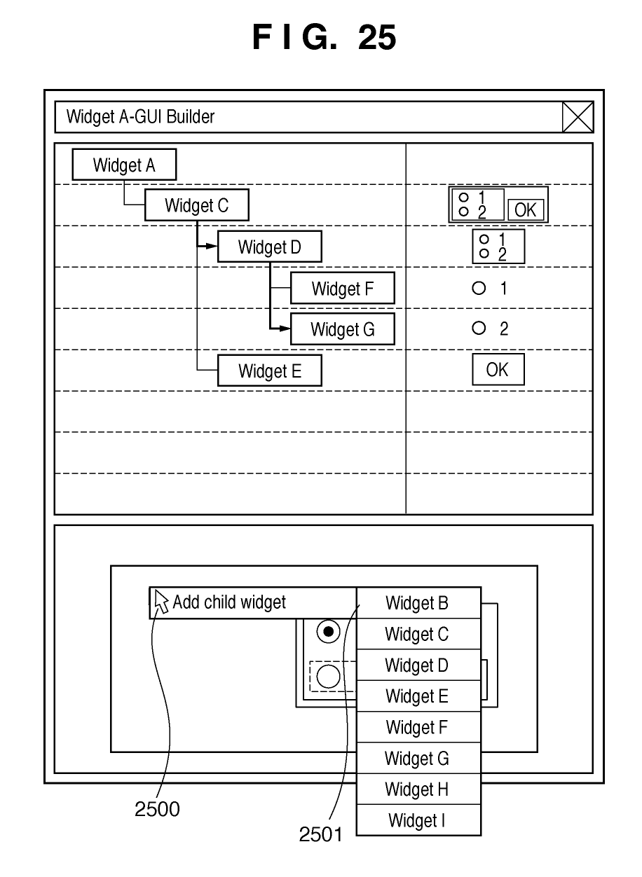

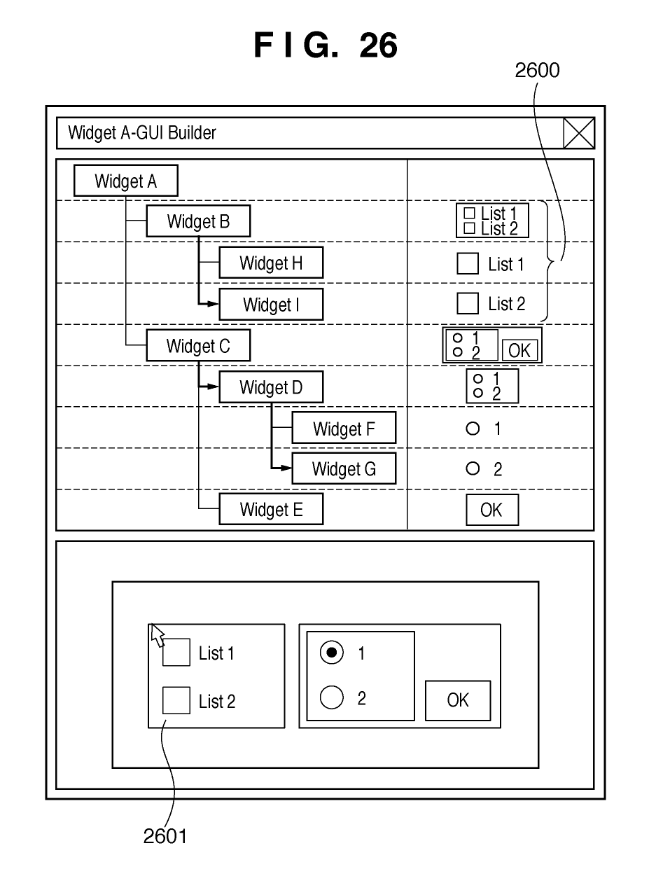

FIG. 25 illustrates a situation in which a UI widget created in the past is re-utilized and the present UI widget is loaded. First, in the UI-widget appearance presentation area, the UI developer C moves a mouse pointer (2500) to a location where a child UI widget is desired to be introduced. If the mouse is right-clicked, this instruction is sent to the UI widget content editing unit 1405 via the user-operation loading unit 1407. Accordingly, a context menu (2501) having an “Add child widget” item is displayed. If the UI developer C selects “Add child widget”, then this instruction is sent to the UI widget content hierarchy building unit 1408. Accordingly, information concerning UI widget content within the storage device 101 is extracted from the UI widget content input/output unit 1404 and a list of this information is presented. Here it will be assumed that UI developer C has selected “Widget B” created earlier. When this is done, “Widget A” comes to possess “Widget B” as a child UI widget in addition to “Widget C” added on already. The UI hierarchy shown in FIG. 6 is then built and “View” of the kind shown in FIG. 26 is presented on the display 102 of UI developer C from the UI widget content presenting unit 1406.

FIG. 26 is a view of the application after “Widget B” has been added on as the child UI widget. The information concerning “Widget B” is added to the UI-widget hierarchical structure presentation area (2600) and UI-widget appearance presentation area (2601). It should be noted that since “Widget B” possesses “Widget H” and “Widget I” as child widgets owing to the foregoing processing, these widgets are added on merely by adding on “Widget B”.

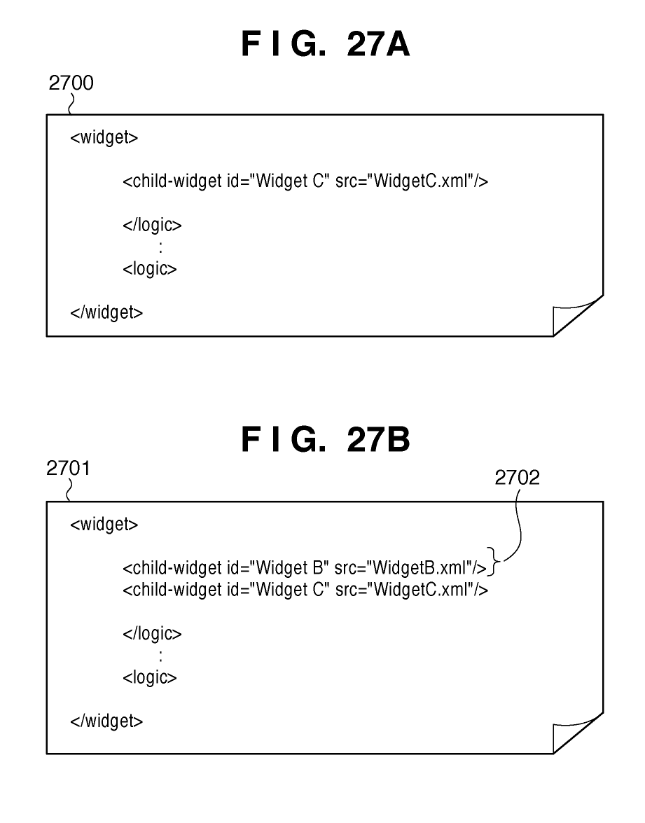

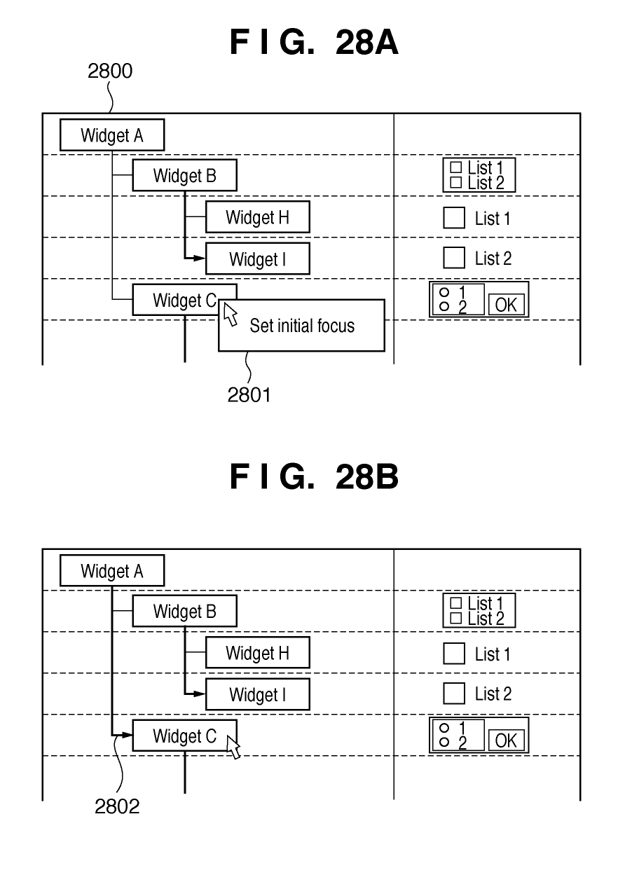

FIGS. 27A and 27B are diagrams illustrating how the UI widget content of “Widget A” is changed by adding “Widget B” onto “Widget A” as a child UI widget. FIG. 27A illustrates the state (2700) which prevails before “Widget B” is added on as the child UI widget. At this stage only “Widget C” has been set as the <child-widget> element. FIG. 27B illustrates the state (2701) which prevails after “Widget B” is added on. Here a <child-widget> element (2702) relating to “Widget B” has been added on anew.

Furthermore, it is also possible to set a child UI widget as the initial focus. FIGS. 28A and 28B illustrate a state in which “Widget C” has been set as the initial focus. First, as shown in FIG. 28A, if the mouse is right-clicked on a child UI widget desired to be set as the initial focus in a UI-widget hierarchical structure presentation area (2800), this instruction is sent to the UI widget content editing unit 1405 via the user-operation loading unit 1407. Accordingly, the context menu (2801) is presented. Next, assume that the UI developer C has selected “Set initial focus” from the context menu presented. When this is done, the instruction is sent to the initial-focus setting unit 1409 and the designated child UI widget is set as the initial-focus widget. An initial-focus display (2802) of the kind shown in FIG. 28B is then output from the UI widget content presenting unit 1406 to the display 102.

Finally, if UI developer C designates that the data is to be saved, this instruction is sent to the UI widget content editing unit 1405 via the user-operation loading unit 1407. Accordingly, the internal data of the UI widget content is sent to the UI widget content input/output unit 1404 and is stored in the storage device 101.

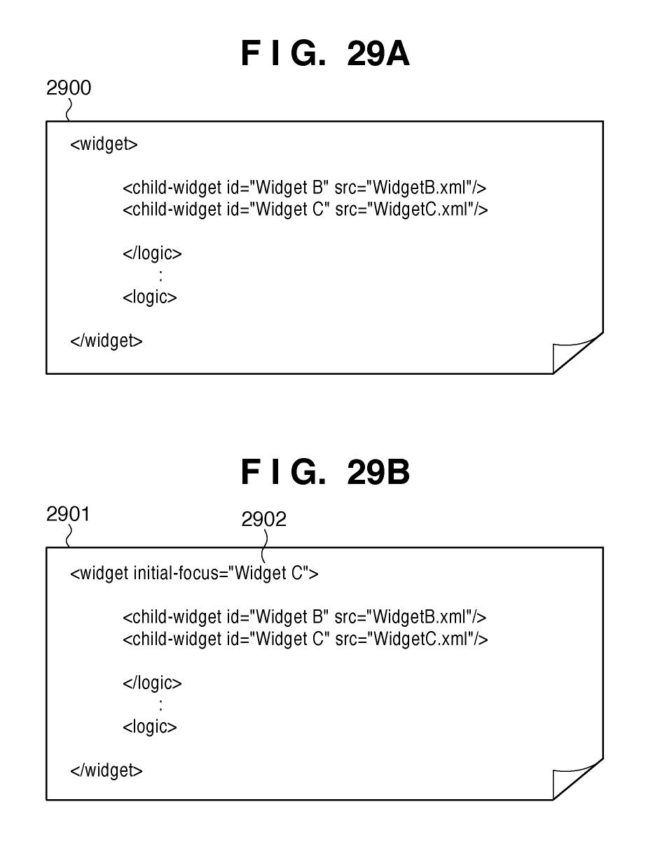

FIGS. 29A and 29B are diagrams illustrating how the UI widget content of “Widget A” is changed by setting the initial focus to “Widget C” under “Widget A. FIG. 29A illustrates the state (2900) which prevails before “Widget C” is set as the initial focus. The <widget> element does not have the attribute called “initial-focus”. FIG. 29B illustrates the state (2901) which prevails after “Widget C” has been set as the initial focus. Here the “initial-focus” attribute has been added on and “Widget C” has been set as the value thereof (2902).

Processing for creating UI widget content anew has been described thus far. Further, processing for adding an already created UI widget onto a UI widget as a child UI widget has been illustrated. In addition, processing for setting a specific child UI widget as the initial focus has been illustrated. By repeating these processing operations, it is possible to build a more complex UI widget hierarchy.

[UI Presenting Apparatus]

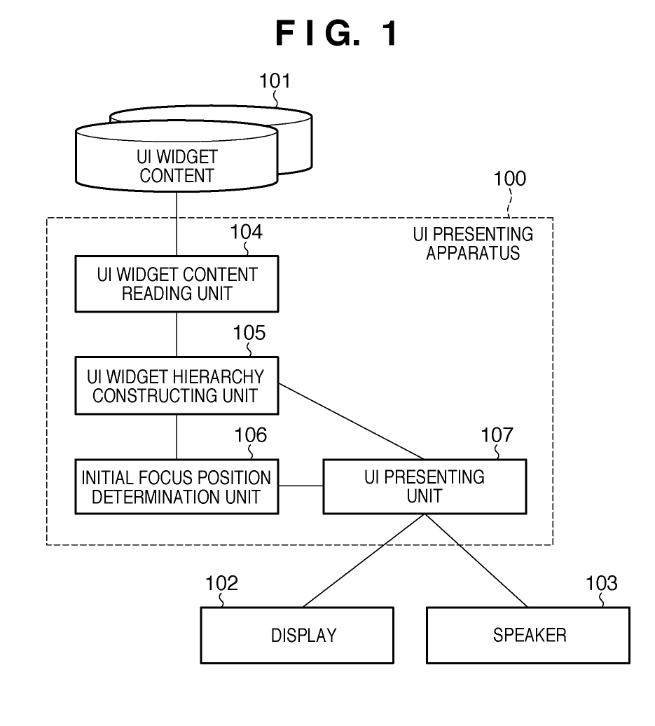

FIG. 1 is a diagram illustrating the functional configuration of a user-interface presenting apparatus (referred to as a “UI presenting apparatus” below) 100 to which the present invention is applicable. The apparatus of this embodiment will be described with reference to FIG. 1.

The UI presenting apparatus 100 in this embodiment presents the user with the UI of a device or service.

The UI presenting apparatus 100 is capable of accessing UI widget content that has been stored in the external storage device 101.

Further, output devices such as the display 102 and speaker 103 are connected to the UI presenting apparatus 100. The user can be presented with images and audio via these output devices.

The UI presenting apparatus 100 has a reading unit 104 for reading UI widget content. The reading unit 104 reads in UI widget content from the external storage device 101.

The UI widget hierarchy constructing unit 105 parses UI widget content that has been read in and builds a hierarchical relationship of UI widgets that form the UI on a single screen. It is possible for the single-screen UI to be formed from a plurality of UI widgets.

From the UI widget hierarchy built by the UI widget hierarchy constructing unit 105, an initial focus position determination unit 106 determines the UI widget having the initial focus. The UI widget having the initial focus is that UI widget among the plurality of built UI widgets that is initially placed in the selected state. The details of this determination processing will be described later.

The information concerning the UI widget hierarchy built by the UI widget hierarchy constructing unit 105 and the information concerning the initial-focus determined by the initial focus position determination unit 106 is sent to a UI presenting unit 107. Using this information, the UI presenting unit 107 builds the UI presented to the user. For example, the UI presenting unit 107 creates the image of a graphical user interface of the kind shown in FIG. 5 and presents the image to the user via the display 102. At this time the UI widget having the initial focus is presented to the user upon manipulating it into an image showing that it is in the selected state. For example, the UI widget is enclosed by a rectangle formed by a dotted line.

The functions of the UI presenting apparatus 100 described above can be implemented by an information processing apparatus such as a personal computer or work station.

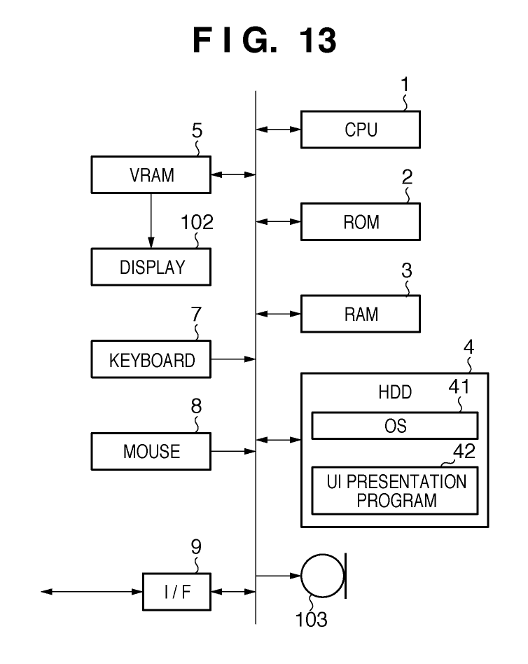

FIG. 13 is a diagram illustrating an example of the hardware configuration of an information processing apparatus for implementing the functions of the UI presenting apparatus 100.

The apparatus includes a CPU 1 for administering overall control of the apparatus; a ROM 2 storing a booting program and permanent data, etc.; a RAM 3 that functions as a main memory and provides a work area for the CPU 1; and a hard-disk drive (HDD) 4, which stores an operating system 41 and a UI presentation program 42. The UI presentation program 42 includes program code corresponding to the functions of the reading unit 104 for reading UI widget content, the UI widget hierarchy constructing unit 105, the initial focus position determination unit 106 and the UI presenting unit 107. The UI presentation program 42 is incorporated in an Internet browser, by way of example.

A VRAM 5 is a memory for expanding the image data that is to be displayed. Expanding image data and the like here makes it possible to display the data on the display 102. A keyboard 7 and mouse 8 are for performing various input operations. An interface (I/F) 9 is for connecting to a network. The above-mentioned speaker 103 is connected to the apparatus.

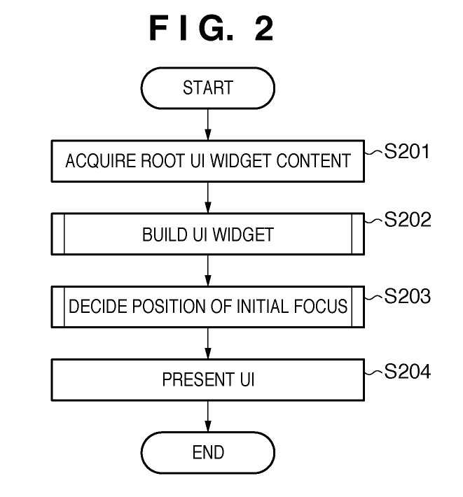

FIG. 2 is a flowchart illustrating processing executed by the UI presenting apparatus.

First, when the user introduces power to the apparatus, the processing having the flow shown in FIG. 2 begins. Alternatively, it may be so arranged that processing begins in a case where the user accesses a desired service as by using an Internet browser.

When processing begins, the reading unit 104 for reading in UI widget content acquires information representing UI widget content that will be the root (S201). The information acquired is stored in the RAM, by way of example. The UI widget that will be the root signifies a UI widget that is the root of the UI widget hierarchy that forms the UI.

UI widgets can be expressed in the form of a hierarchy by using a tree structure or the like. For example, if a certain UI widget A is a UI widget that employs other UI widgets B and C, then the UI widget A will be the parent of the UI widgets B and C. Thus, UI widgets can be expressed in hierarchical form and the information representing the UI widget content that will constitute the root of this hierarchy is obtained by this processing. Often the UI widget that will be the root is designed as a UI widget representing one screen of the UI, generally speaking. The UI widget content that will the root is decided on a per-device or per-service basis. In the case of a device, the information (content ID or URI information thereof) of the UI widget content that will the root is stored in the memory of the device. Further, in the case of the UI of a service, there are instances where the information (URI information) of the UI widget content that will be the root is appended to content such as the HTML of the service.

When the UI widget content that will be the root is acquired, the UI widget hierarchy constructing unit 105 builds the UI widget based upon this content information (step S202). This processing will be described later. When the root UI widget is built, the initial focus position determination unit 106 decides the position of the initial focus based upon this UI widget (step S203). This processing also will be described later.

When the root UI widget is built and the position of the initial focus thereof is decided, the UI presenting unit 107 generates the actual UI based upon this information and presents it to the user (step S204). For example, the UI presenting unit 107 creates an input-form group, which is for ordering pizza, as a graphical user interface and presents the GUI from the display of the user.

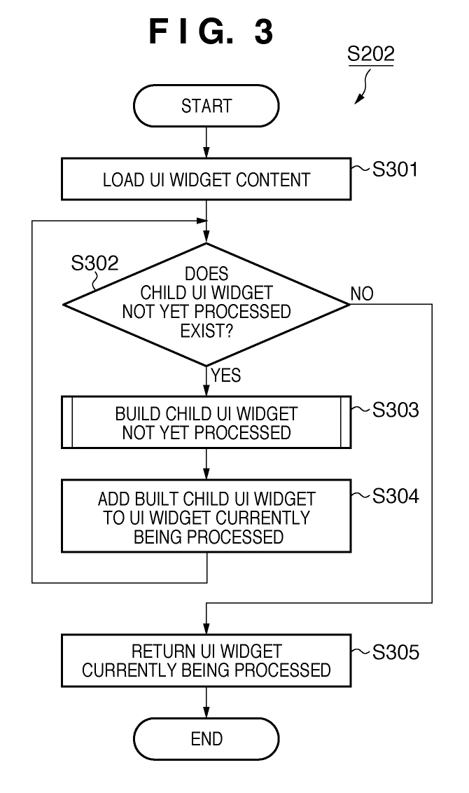

FIG. 3 is a flowchart of processing of step S202 for building a UI widget based upon content information. This processing adopts information representing UI widget content as an argument. This information is an ID representing the UI widget content or the URI of the UI widget content.

When the processing begins, loading of the UI widget content is performed based upon the information representing UI widget content (step S301). In a case where the information representing the UI widget content given by the argument is the ID, a correspondence table or the like giving the correspondence between IDs and UI widget content is referred to and the UI widget content is acquired. In a case where the information representing the UI widget content given by the argument is the URI, the UI widget content is acquired from within the device or via a network based upon the URI information.

FIG. 8 shows an example of UI widget content of the portion 504 in the UI shown in FIG. 5. The UI widget content may be described in the XML format in the manner shown. UI widget content 801 includes a description of reference information 803 by which its own UI widget refers to the child UI widgets, and a description of information 802 specifying which of the UI widgets, namely the its own UI widget or the child UI widgets, is to receive the initial focus. In the example of FIG. 8, its own UI widget (the radio-button group) has two radio buttons radio1 and radio2, which are associated with the radio-button group, as the child UI widgets, and the child UI widget of radio1 is defined as having the initial focus.

When the UI widget content of FIG. 8 is acquired, then the UI widget content is parsed and whether the UI widget of interest has a child UI widget is determined (step S302). In the case of the content of FIG. 8, the information 803 is information relating to the child UI widgets. This example indicates that the child UI widgets radio1 and radio2 are possessed as the child UI widgets. The loop that starts from step S302 indicates that the processing of steps S303 and S304 is executed for every child UI widget.

At step S303, the building of the child UI widget is performed based upon the information indicating the content of the child UI widget. The information indicating the content of the child UI widget is the ID information of the child UI widget or the URI information to this UI widget content. Processing indicated by this processing flow is executed using these items of information as the argument and the building of the child UI widget is carried out.

The child UI widget generated is added on as the child UI widget of the UI widget currently being processed (step S304). The generation (step S303) of the child UI widget and the adding on of the child UI widget (step S304) are carried out with regard to all child UI widgets of the UI widget currently being processed. When all of the child UI widgets defined by the UI widget content have been processed, control proceeds to the processing of step S305.

At step S305, the UI widget currently being processed is returned to the side (FIG. 2) that calls the present flow. As a result, by executing this processing flow, the UI widget hierarchy having the entered UI widget as the root is built and returned to the calling side.

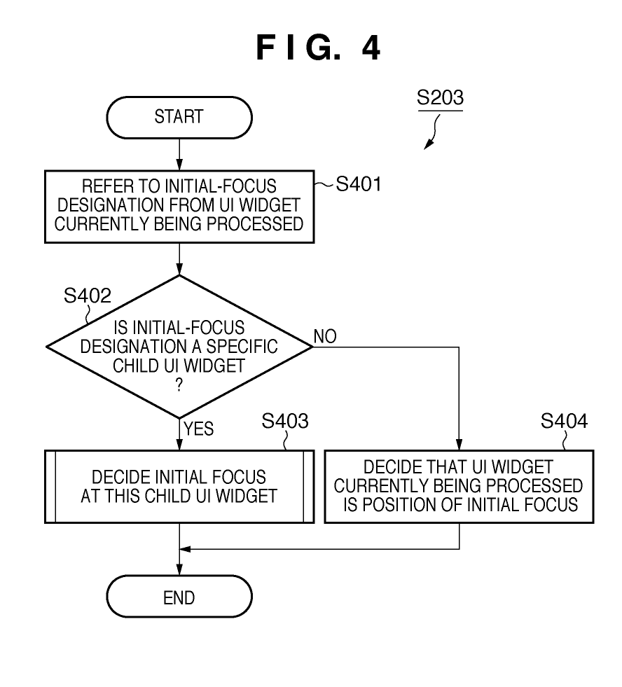

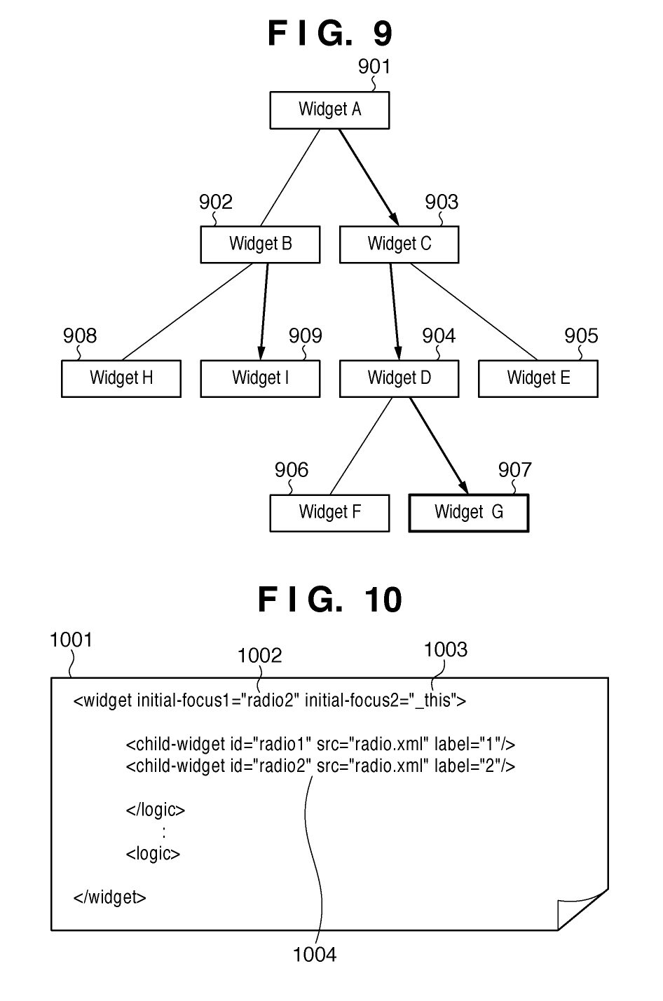

FIG. 4 is a flowchart illustrating the processing of step S202 for deciding initial focus based upon the UI widget hierarchy. This flow begins with the argument being the root UI widget of the UI widget hierarchy generated by the processing of FIG. 3. For example, in a case where the UI widget hierarchy generated by the processing of FIG. 3 is a hierarchy of the kind shown in FIG. 9, the UI widget indicated at 901 is the root UI widget. The root UI widget is the UI widget that will be the root of the UI hierarchy, e.g., the top UI widget (the screen UI widget, for example) that forms one screen.

Here the description will be rendered assuming that this flow begins with the UI widget 901 in the UI widget hierarchy of FIG. 9 serving as the argument. First, reference is had to the designation of the initial focus of the UI widget (initially the root UI widget 901) currently being processed (step S401). The initial-focus designation is information indicating which of the UI widgets, namely its own UI widget or the child UI widgets, has the initial focus. In the case of the UI content shown in FIG. 8, for example, it is possible for this information to be designated by the description (“initial-focus” attribute) at 802. This information is left in the UI widget hierarchy generated by the processing shown in FIG. 3. In FIG. 9, for example, the bold arrows represent the initial-focus information. For instance, the information in FIG. 9 indicates that the UI widget 901 in FIG. 9 has two child UI widgets and that “Widget C” (903) of these two child UI widgets possesses the initial focus.

In a case where a UI widget A that is other than the UI widget being processed is designated as the initial focus (“YES” at step S402), it is decided that the initial focus is at this UI widget A (step S403). This processing corresponds to calling this flow recursively with this UI widget A serving as the argument. For example, in a case where it is described in the UI widget content of “Widget A” that “Widget C” possesses the initial focus, the flow of FIG. 4 is called with “Widget C” serving as the argument.

In a case where the initial-focus designation is not referring to another UI widget A (“NO” at step S402), it is decided that the UI widget currently being processed possesses the initial focus (step S404). For example, this corresponds to a case where the UI widget currently being processed does not have a child UI widget or to a case where the UI widget content currently being processed has a description such as “initial-focus=‘_this’” and thus designates itself as having the initial focus. Further, it corresponds also to a case where an initial-focus attribute per se has not been designated and, hence, no initial focus has been designated.

If the flow of FIG. 4 begins with the UI widget 901, which is the root of the UI widget hierarchy shown in FIG. 9, then the initial-focus designation transitions from “Widget A” to “Widget C” to “Widget D” to “Widget G”. Thus “Widget G” finally becomes the UI widget having the initial focus.

In accordance with the UI presenting apparatus according to this embodiment described above, it is possible to determine an initial focus that incorporates the intentions of each of the UI developers. For example, assume that a UI developer A who created a UI widget referred to as “Widget B” (902) in FIG. 9 designated “Widget I” (909) as the initial focus from “Widget B”, and that a UI developer B who created a UI widget referred to as “Widget C” (903) designated “Widget G” (907) as the initial focus. Then assume that a UI developer C re-utilizes these UI widgets and creates “Widget A” having the “Widget B” and the “Widget C” as child UI widgets. Assume that the UI developer considers which of “Widget B” and “Widget C” he desires to receive the initial focus and decides to furnish “Widget C” with the initial focus. This results in the initial focus being given to the child UI widget “Widget G” of “Widget C”. Thus, the intentions of developers B and C are reflected in the determination of initial focus.

### Second Embodiment

This embodiment illustrates an example in which the UI presenting apparatus of the first embodiment is installed in a GUI presenting unit of a copier equipped with a facsimile function.

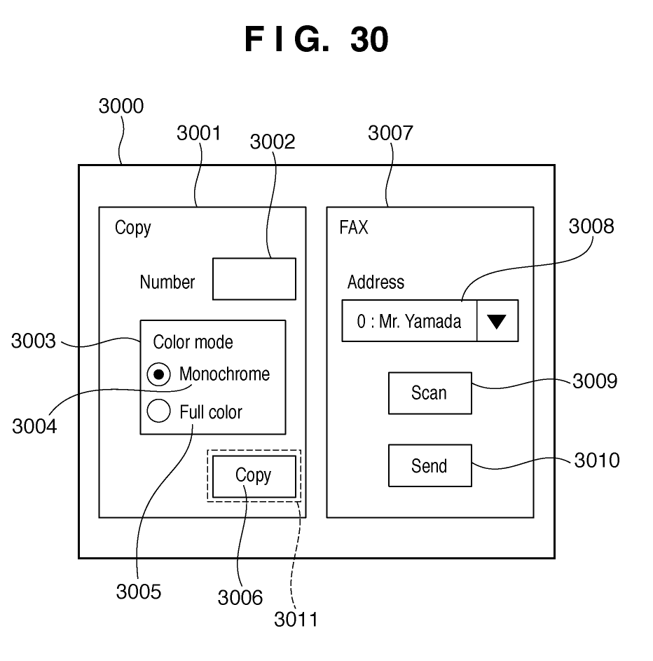

FIG. 30 illustrates an example of the GUI of a copier equipped with the facsimile function. The GUI is such that a UI widget (3001) relating to copying and a UI widget (3007) relating to facsimile are displayed on a screen (3000).

The UI widget relating to copying has an edit box (3002) in which the number of copies can be entered, radio buttons (3003) for selecting the color mode, and a button (3006) that enables printing to be executed by being clicked. The radio buttons for selecting the color mode include two radio-button elements (3003) and (3004) and it is possible for the user to select either one.

The UI widget relating to facsimile includes a list box (3008) in which a registered destination for a facsimile transmission has been stored, a scan button (3009) for reading in a document that has been placed on a glass platen, and a facsimile execution button (3010) for transmitting a read document to the selected transmission destination.

The user is capable of selecting the data for this UI by using direction keys, numeric keys and a decision key and of executing various operations. For example, focus (3011) on a UI widget can be moved by pressing a direction key. By moving the focus onto various buttons and then pressing the decision key, the button can be clicked. By moving the focus onto the edit box and pressing a numeric key, the value corresponding to the numeral can be entered in the edit box. By moving the focus onto the list box and pressing a numeric key, the list element corresponding to the numeral can be selected.

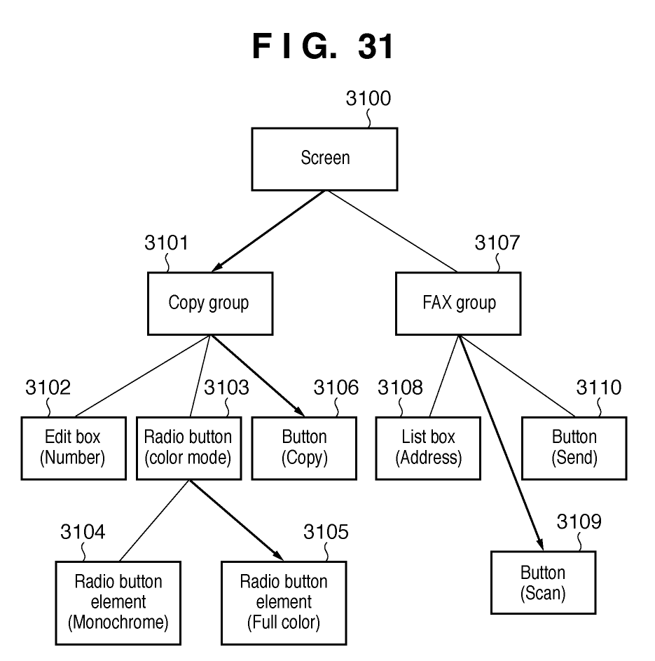

FIG. 31 is a diagram expressing the UI of FIG. 30 in the form of a UI widget hierarchy. The UI widgets (3000) to (3010) correspond to elements (3100) to (3110), respectively, in FIG. 31. The bold-line arrows in FIG. 31 represent the initial-focus designations of the respective UI widgets.

For example, UI widget (3101) corresponding to copying has, as child UI widgets, edit box (3102) in which the number of copies can be entered, radio buttons (3103) for selecting the color mode and button (3106) that enables printing to be executed by being clicked. The UI widget (3101) relating to copying designates the copy button (3106) as the initial focus. Further, the radio buttons (3103) for selecting the color ode have two radio-button elements (3103) and (3104) as child UI widgets. Of the radio buttons (3103), the first radio-button element (3103) is designated as the initial focus.

If such UI widget content is loaded from the storage device 101 via the reading unit 104, then the UI presenting apparatus presents the UI in a state in which the initial focus has been applied thereto. Specifically, the UI widget hierarchy constructing unit 105 generates the hierarchy of the root UI widget. The initial focus position determination unit 106 follows the path from the root UI widget to the UI widget that has been designated to receive the initial focus. The initial focus position determination unit 106 then decides upon the UI widget, which has been designated to receive the initial focus, as the UI widget having the initial focus, and the UI for which the initial focus has thus been set is output to the display 102, etc., by the UI presenting unit 107.

For example, if the UI widget hierarchy of FIG. 31 is loaded, the UI presenting apparatus follows the path from the root UI widget to the UI widget designated to receive the initial focus. The root UI widget is widget 3100 and widget 3101 is indicated as the designation for initial focus. If the next designation of initial focus of widget 3101 is followed, one arrives at UI widget 3106. Since UI widget 3106 is not designating another UI widget as the initial focus, this UI widget is regarded as the UI widget having the initial focus. As a result, when this UI is presented the first time, it is presented to the user with the initial-focus border surrounding the copy button (3106).

The foregoing makes it possible for the re-utilization of the UI to be performed effectively. For example, the UI developer who created the UI widget relating to copying decided that it would be appropriate for the copy button (3106) to receive the initial focus and thus designed the UI accordingly. The reason is that the developer judged that enabling copying to be performed merely by placing a document on the glass platen and clicking the decision key would be a desirable design for a copier. On the other hand, the UI developer who created the UI widget relating to facsimile decided that it would be appropriate for the scan button (3109) to receive the initial focus. The reason is that this developer judged that enabling a document to be read merely by placing the document on the glass platen and clicking the decision key would be a desirable design for a facsimile machine. A UI developer who has incorporated these two UI widgets (3101 and 3107) would adopt the initial-focus setting of the UI widget (3101) relating to copying. The reason is that this developer has judged that this product would be used more often as a copier than as a facsimile machine. By thus using the present invention, the finally appropriate initial-focus setting is made merely by deciding which UI widget that is one layer lower in the hierarchy should receive the initial focus.

### Third Embodiment

In the first and second embodiments described above, a single UI widget is designated in each type of UI widget content as the widget to receive the initial focus. However, it is also possible to designate a plurality of such widgets.

FIG. 10 illustrates an example in which a plurality of UI widgets have been designated as widgets to receive the initial focus. In addition to a first initial-focus designation 1 indicated at 1002 in UI widget content 1001, a second initial-focus designation 2 indicated at 1003 is described in the UI widget content 1001.

In the event that the building of the UI widget described in the initial-focus designation 1 fails for some reason, the initial focus is given to the UI widget described in the second initial-focus designation 2. For example, if the “radio2” UI widget content (“radio.xml”) in FIG. 10 cannot be accessed, then the UI widget representing “_this” (self) receives the initial focus.

By thus making a plurality of initial-focus designations, it is possible to decide initial focus from one that can be utilized as a child UI widget and, moreover, that has been designated as an initial focus of a higher order.

### Fourth Embodiment

This embodiment illustrates an example in which the UI presenting apparatus of the third embodiment is installed in a GUI presenting unit of a copier equipped with a facsimile function.

FIG. 30 illustrates an example of the GUI of a copier equipped with the facsimile function. The GUI is such that UI widget (3001) relating to copying and UI widget (3007) relating to facsimile are displayed on screen (3000).

The UI widget relating to copying has edit box (3002) in which the number of copies can be entered, radio buttons (3003) for selecting the color mode, and button (3006) that enables printing to be executed by being clicked. The radio buttons for selecting the color mode include two radio-button elements (3003) and (3004) and it is possible for the user to select either one.

The UI widget relating to facsimile includes list box (3008) in which a registered destination for a facsimile transmission has been stored, scan button (3009) for reading in a document that has been placed on a glass platen, and facsimile execution button (3010) for transmitting a read document to the selected transmission destination.

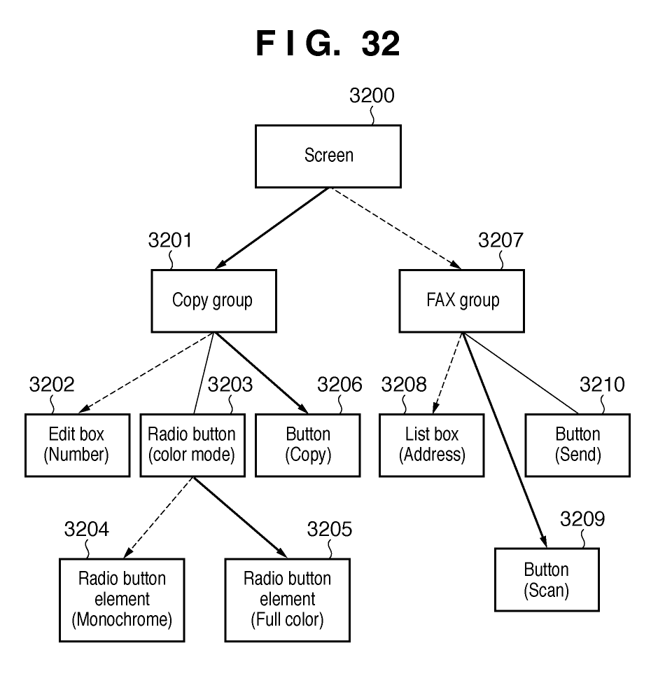

FIG. 32 is a diagram expressing the UI of FIG. 30 in the form of a UI widget hierarchy. The UI widgets 3000 to 3010 correspond to elements 3100 to 3110, respectively, in FIG. 31. The bold-line arrows in FIG. 32 represent the initial-focus designations of the respective UI widgets, and the dashed-line arrows correspond to second initial-focus designations.

For example, screen (3200) has, as child UI widgets, UI widget (3201) relating to copying and UI widget (2307) relating to facsimile. Assume that UI widget (3201) relating to copying is designated as the first initial-focus designation and that UI widget (3207) relating to facsimile is designated as the second initial-focus designation.

If such a UI widget hierarchy is loaded, the path of the initial-focus designation is followed from the root UI widget content and the UI widget arrived at is decided upon as the UI widget having the initial focus according to the described rendered thus far.

However, consider a situation where UI widgets that follow a specific UI widget have become unusable. For example, assume that paper has run out in a copier equipped with a facsimile function and that the copying application that uses paper has become unusable as a consequence. In this case, for example, the copying-related UI cannot be accessible. Naturally, the initial focus cannot be given to a UI that is not accessible.

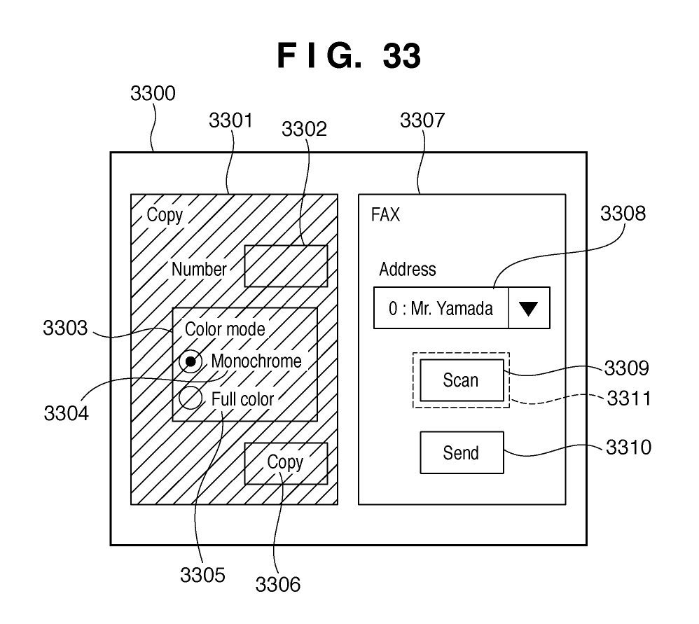

For example, if a copier equipped with a facsimile function runs out of paper, a GUI of the kind shown in FIG. 33 is desirable. As shown in FIG. 33, the UI (3301, 3302, 3303, 3304, 3305, 3306) relating to copying using paper is grayed-out to notify the user that it cannot be accessed. In addition, the initial focus (3311) effective when this screen is displayed can be applied to a UI widget other than one in the copying-related UI.

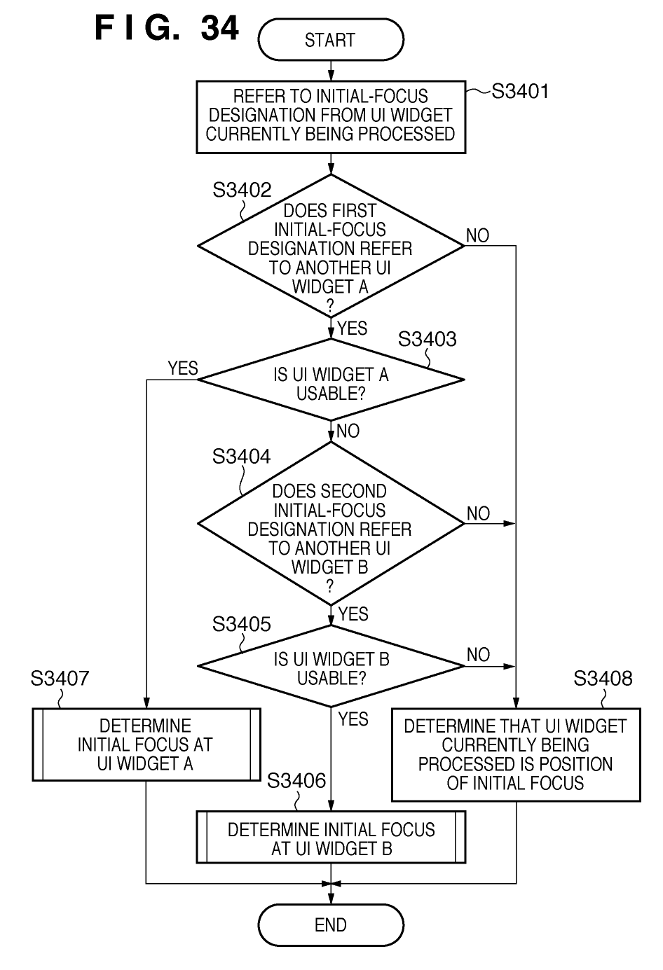

FIG. 34 illustrates the flow of a routine for deciding initial focus in such case. The flow is executed accompanied by the root UI widget content. For example, in the case of the UI widget hierarchy of FIG. 32, the flow is executed accompanied by the UI widget content relating to “Screen”, which is the root.

First, reference to the initial-focus designation is made from the UI widget currently being executed (S3401). In the case of “Screen” in FIG. 32, for example, the copying-related UI (3201) is acquired as the first initial-focus designation and the facsimile-related UI (3207) is acquired as the second initial-focus designation.

Next, it is determined whether the first initial-focus designation is referring to another UI widget A (S3402). Currently the first initial-focus designation is the copying-related UI (3201). Next, it is determined whether this UI widget A is usable (S3403). Here a “NO” decision is rendered because paper has run out and the copying-related UI cannot be utilized.

Next, it is determined whether the second initial-focus designation is referring to another UI widget B (S3404). Currently the second initial-focus designation is the facsimile-related UI (3207). Next, it is determined whether this UI widget B is usable (S3405). Here it is determined that the UI widget B can be used. Accordingly, the initial focus is determined at UI widget B. In other words, the flow of FIG. 34 is executed accompanied by the UI (3207) relating to facsimile, which is UI widget B.

If the flow of FIG. 34 is executed accompanied by the facsimile-related UI (3207), the initial focus is determined at the scan button (3209) by the processing of step S3407. If the flow of FIG. 34 is executed accompanied by the scan button (3209), then the scan button (3209) is decided upon as the initial focus by the processing of step S3408.

Thus, it is decided that the scan button (3209) has the initial focus and, as illustrated in FIG. 33, this is presented to the user in a state in which the initial focus (3311) has been applied to the scan button (3309).

In this way it is so arranged that initial focus can be designated up to a maximum of two child UI widgets. This means that if one of the child UI widgets can no longer be utilized, then it is possible to designate the other child UI widget as the initial focus.

### Fifth Embodiment

In the third and fourth embodiments, the initial-focus designations are made in the form of the first initial-focus designation and second initial-focus designation. However, it is possible to set three or more candidates for initial focus.

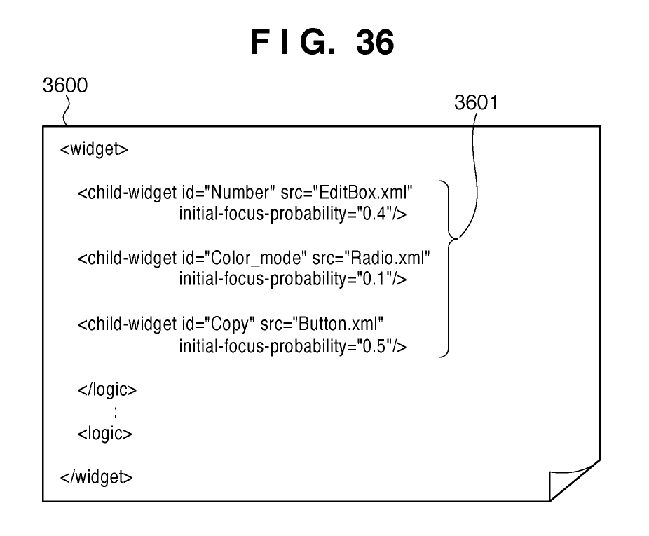

For instance, FIG. 36 illustrates an example of UI widget content in which numerical values of 0 to 1 have been assigned in the form of initial-focus probabilities to designations of initial focus. Specifically, UI widget content (3600) has three child UI widgets, namely “Number”, “Color_mode” and “Copy”, and values of “0.4”, “0.1”, “0.5” have been set (3601) as the probabilities that the initial focus will be applied to the respective child UI widgets. These probabilities are expressed as the “initial-focus-probability” of the <child-widget> element.

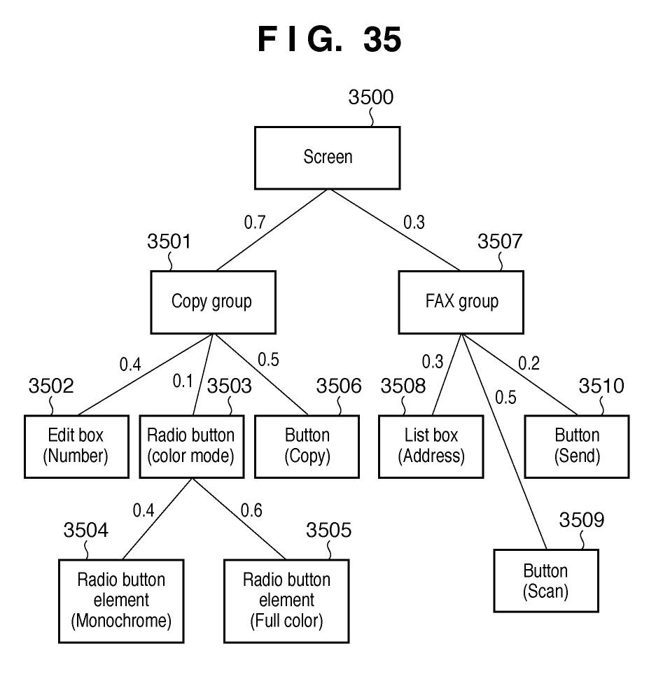

It should be noted that FIG. 35 is the diagram that results when the UI widget hierarchical structure of FIG. 32 is re-expressed in the form of such initial-focus probability. Instead of arrows representing the designation of initial focus, numerical values of 0 to 1 are assigned to the lines representing the parent-child relationship. The larger the numerical value, the higher the probability that the child UI widget will receive the initial focus. It should be noted that unity (1.0) is the sum-total of the initial-focus probabilities of child UI widgets possessed by a single parent.

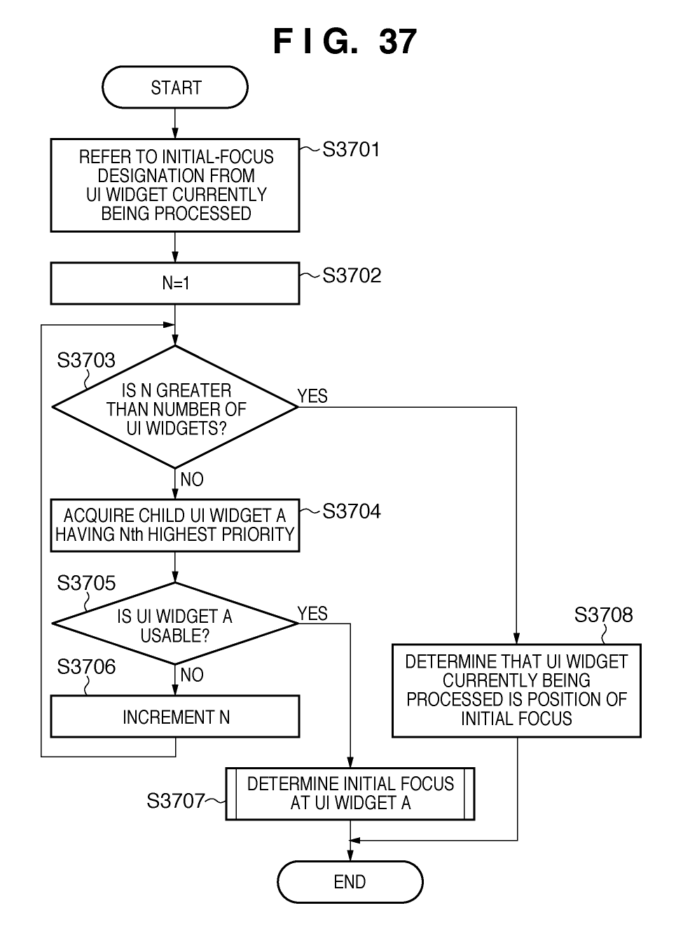

FIG. 37 illustrates the flow of a routine for deciding initial focus in such case. The flow is executed accompanied by the root UI widget content. For example, in the case of the UI widget hierarchy of FIG. 35, the flow is executed accompanied by the UI widget content relating to “Screen” (3500), which is the root.

First, reference to the initial-focus designation is made from the UI widget currently being executed (S3701). In the case of “Screen” (3500) in FIG. 32, for example, “0.7” and “0.3” are acquired as the respective initial-focus designations of the copying-related UI (3501) and facsimile-related UI (3507).

Next, an internal variable N is initialized at 1 (S3702).

Next, it is determined whether N is greater than the number of child UI widgets (S3703). Since N is 1 at the present time and this is not greater than 2, which is the number of children of the UI widget, a “NO” decision is rendered. The child UI widget having the Nth highest priority is acquired (S3704). This processing acquires the UI widget (3501), which is the copying-related UI. This is the UI widget having the highest priority.

Next, it is determined whether the acquired UI widget is usable (S3705). Assume that paper has run at present, rendering the copying-related UI unusable. In this case, processing for incrementing N is executed (S3706). As a result, N is changed to 2. Control then returns to the decision step S3703 to determine whether N is greater than the number of child UI widgets.

Since 2, which is the current value of N, is not greater than the number (2) of child UI widgets, the facsimile-related UI widget (3507), which is the UI widget having the second highest priority, is acquired. It is determined whether this UI widget is usable (S3705). Although paper has run out, a “YES” decision is rendered because absence of paper does not affect use in relation to a facsimile transmission. Control therefore proceeds to S3707, where the flow is executed with the facsimile-related UI widget (3507) now serving as the argument.

When the flow is executed with the facsimile-related UI widget (3507) as the argument, the scan button (3509), which is the UI widget when N is 1, is selected (S3704) and it is determined that this UI widget is usable (“YES” at S3705). At S3707, the flow is executed with the UI widget (3509) relating to the scan button now serving as the argument.

When the flow is executed with the UI widget (3509) relating to the scan button as the argument, a “YES” decision is rendered at the processing of S3703 because this UI widget does not have a child UI widget. The UI widget (3509) relating to the scan button, which is the UI widget currently being processed, is decided upon as the UI widget having the initial focus.

As a result, the UI widget having the initial focus is decided and, when the UI is presented as shown in FIG. 33, it is possible to present the interface in a state in which the initial focus (3311) has been applied to the UI widget at 3707.

In the fourth embodiment, the initial-focus designation can be made up to a maximum of two child UI widgets. In a case where one child UI widget can no longer be utilized, therefore, the initial focus can be applied to the other UI widget. However, if both of the UI widgets designated to receive the initial focus become unusable, then the initial focus cannot be applied to the appropriate location.

With the method of the fifth embodiment, on the other hand, it is possible to perform the initial-focus designation in a form in which all child UI widget are assigned a priority. As a result, even if a plurality of these child UI widgets become unusable, it is possible to apply the initial-focus designation to the UI widget having the highest priority among the usable child UI widgets.

### Sixth Embodiment

A method of deciding initial focus in a UI widget hierarchy has been described in the first to fifth embodiments. However, the present invention can also be applied to processing other than processing for deciding initial focus.

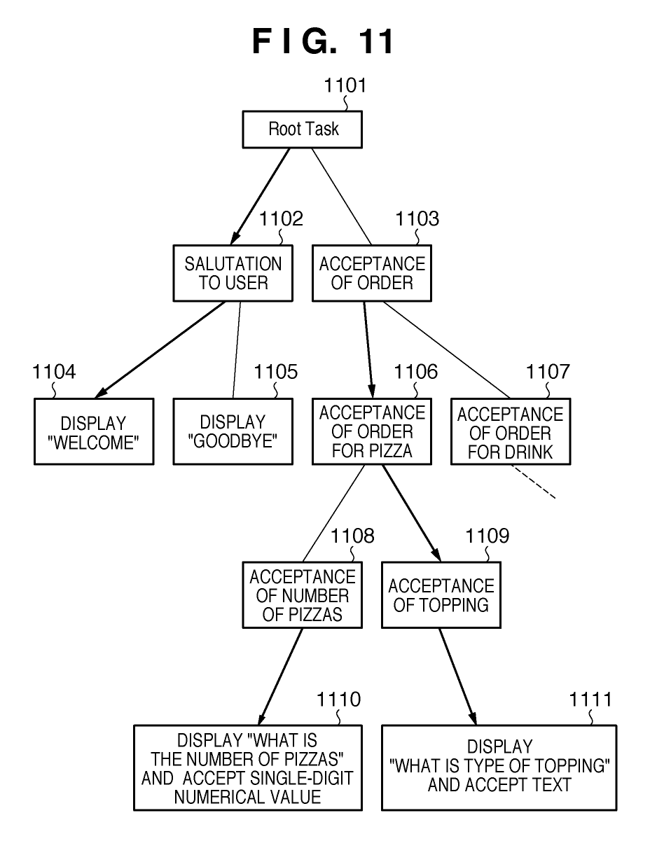

For example, FIG. 11 illustrates a task hierarchy of a UI employed by a pizza ordering service. A task is an operation that is to be achieved by a UI presenting apparatus by the time the service is completed. “Root Task” (1101), which is the root of this hierarchy, has as its duty to accept an order for pizza and a drink from the user. The root task has link information linked to two child task elements, namely “Salutation to user” (1102) and “Acceptance of order” (1103), into which the processing content has been broken down in order that the duty may be achieved. Thus the task element is broken down into child task elements and becomes a specific command “Display ‘What is the number of pizzas?’ and accept single-digit numerical value”.

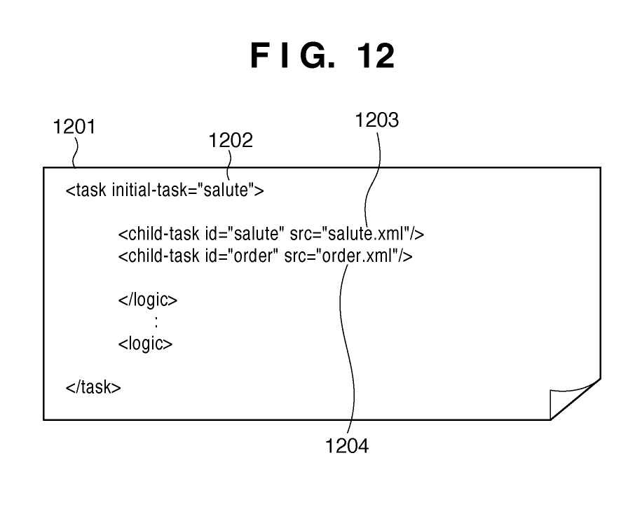

Assume that when a task element designates a child task element, information as to which child task element is executed first has been designated. For example, FIG. 12 illustrates an example of task content that expresses “Root Task”. Child tasks “Salutation to user” (1203) and “Acceptance of order” (1204) have been declared in “Root Task” (1201) and of these, “Salutation to user” has been designated at the initial task (1202).

The UI presenting apparatus builds the task hierarchy of FIG. 11 from the task content that has been designated as the root. Using the task hierarchy built, the apparatus refers to the corresponding initial-task information from the root task and decides the task that will become the initial task. The algorithm in this case makes possible application in which “UI widget” and “initial task” in FIGS. 2 to 4 are replaced with “Task” and “initial task”, respectively.

Further, in a manner similar to that of the second embodiment, a plurality of initial tasks may be designated in task content, as by describing second initial-task information in addition to first initial-task information, thereby preparing for the occurrence of failure in the building of the task elements. In this case, it is possible to decide an initial task from one that can be utilized as a child UI task and, moreover, that has been designated as an initial task of a higher order.

Thus, as described above, the present invention is capable of being utilized in a case where it is desired to provide a single solitary UI element (UI widget or task) with a specific meaning (initial focus or initial task) in the expression of a UI represented hierarchically.

### Seventh Embodiment

In the embodiments set forth above, UI widget content or task content is described as a file written in the XML format. However, it should be understood that this is merely one example. Each type of content may be content written according to an existing language specification such as the HTML format. Further, the content may be byte code obtained by binarizing XML. Further, the content may be a source file, header file or interface file in an existing programming language such as C or Java. Alternatively, the format may be a unique data format that expresses a UI.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention can be implemented by a computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a storage medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-104946, filed Apr. 14, 2008, and Japanese Patent Application No. 2009-089582, filed Apr. 1, 2009, which are hereby incorporated by reference herein in their entirety.

What is claimed is:

1. An information processing apparatus for presenting a user interface (UI), comprising:
a reading unit configured to read widget content in which arrangement of UI widgets is described;
a building unit configured to parse the widget content that has been read and build a plurality of UI widgets;
a determining unit configured to determine a UI widget having initial focus placed in a selected state first from among the plurality of UI widgets built; and
a presenting unit configured to create images of the plurality of UI widgets and to process the UI widget having the initial focus, which has been determined by said determining unit, into an image representing that this UI widget is in the selected state, and present this image to the user;
wherein the widget content includes reference information by which its own UI widget refers to a child UI widget, and a description of an initial-focus designation for designating which of its own UI widget and child UI widget will have the initial focus;
said building unit generates its own UI widget and thereafter generates a child UI widget, which is associated with its own UI widget, based upon the reference information, thereby building a UI widget hierarchy; and
said determining unit follows a path from a root of the UI widget hierarchy to a child UI widget designated by the corresponding initial-focus designation and, when a UI widget for which a child UI widget has not been designated in the corresponding reference information, a UI widget for which its own UI widget has been designated in the corresponding initial-focus designation or a UI widget for which there is no corresponding initial-focus designation has been retrieved, determines that this UI widget is the UI widget having the initial focus.

2. The apparatus according to claim 1, wherein with regard to its own UI widget, the widget content includes a description of a first initial-focus designation and a description of a second initial-focus designation different from the first initial-focus designation; and
in a case where said building unit has failed to build a UI widget designated by the first initial-focus designation, said determining unit determines that a UI widget designated by the second initial-focus designation is the UI widget having the initial focus.

3. A method of controlling an information processing apparatus for presenting a user interface (UI), comprising:
a reading step of reading widget content in which arrangement of UI widgets is described;
a building step of parsing the widget content that has been read and building a plurality of UI widgets;
a determining step of determining a UI widget having initial focus placed in a selected state first from among the plurality of UI widgets built; and
a presenting step of creating images of the plurality of UI widgets and processing the UI widget having the initial focus, which has been determined at said determining step, into an image representing that this UI widget is in the selected state, and presenting this image to the user;
wherein the widget content includes reference information by which its own UI widget refers to a child UI widget, and a description of an initial-focus designation for designating which of its own UI widget and child UI widget will have the initial focus;
said building step generates its own UI widget and thereafter generates a child UI widget, which is associated with its own UI widget, based upon the reference information, thereby building a UI widget hierarchy; and
said determining step follows a path from a root of the UI widget hierarchy to a child UI widget designated by the corresponding initial-focus designation and, when a UI widget for which a child UI widget has not been designated in the corresponding reference information, a UI widget for which its own UI widget has been designated in the corresponding initial-focus designation or a UI widget for which there is no corresponding initial-focus designation has been retrieved, determines that this UI widget is the UI widget having the initial focus.

4. A computer-readable storage medium storing a program for causing a computer to execute the method of control set forth in claim 3.
